(19) United States
(12) Patent Application Publication
(10) Pub. No.: US 2008/0086219 A1
(43) Pub. Date: Apr. 10, 2008

(54) System and method for coordinating remote response services

(76) Inventors: Greg Evans, New South Wales (AU); Craig Harvey, New South Wales (AU); Max Celima, Dunlop (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/543,318

(22) Filed: Oct. 4, 2006

(51) Int. Cl. G05B 15/02

(52) U.S. Cl. 700/9; 700/1

(57) ABSTRACT

A system for coordinating remote response services, such as emergency services for safeguarding populations during environmental and other disasters, such as storms, floods, fire in order to ensure that resources are appropriately allocated and emergencies dealt with. The system comprises a host computing system and a number of remote computing systems. The host computing system may be operated by a Management Unit and remote computing systems by remote (field) Units. Each computing system includes the facility to enable entries of Requests For Assistance (RFA) and allocation of tasks responses to the RFAs. A Request For Assistance will include RFA data comprising location data, provided information data on the location of an RFA incident, an incident data, providing emergency information on the incident. The computing systems include sufficient functionality as such that in cases of communications breakdown, RFAs can still be managed. A number of other features are included in the computing system to facilitate organisation of emergency response.

### FIELD OF THE INVENTION

The present invention relates to a system and method for co-ordinating remote response services, and particularly, but not exclusively, for co-ordinating operations of emergency services.

### BACKGROUND OF THE INVENTION

Many countries (and even regional governing bodies, such as the UN) have emergency service organisations which are arranged to organise response to environmental and other emergencies, such as floods, fire, storm, in order to see to the welfare of affected persons and communities.

For example, in the State of New South Wales in Australia, the State Emergency Service, was formed in April 1955 after disastrous floods caused considerable loss of life and massive damage to property and infrastructure on the north coast, in the northern inland of the State and in the Hunter Valley. The NSW State Emergency Service (SES) is responsible for dealing with flood and storm emergencies including the protection of life and property and co-ordinating the evacuation and welfare of affected communities. This accounts for more than two thirds of the dollar costs of natural disasters in New South Wales.

The SES is made up of approximately 10,000 volunteers and 130 members of staff. There are 229 volunteer Units operating at the local level based on council boundaries that provide services to the community. Every local council in the State has a SES presence. Each Unit has an operations centre from which it co-ordinates its activities. It is not uncommon for Units in the more populous areas of the State to have more than 100 members.

The SES is divided into 17 Regions that co-incide with the major river systems. Each Region has a headquarters staffed by three paid staff including a Regional Controller, who leads the Region and is responsible for the operational control of emergency response for the SES. The Regional Headquarters provides administrative support to the Units in their area and has a fully functioning operations centre and a group of volunteers who help with training, planning, operations and other functions.

The SES State Headquarters is based in Wollongong, New South Wales, and co-ordinates training, planning and operational activities, supplies and equips the volunteer Units and operates the organisation's human resources, corporate services and public relations functions.

The most important asset of the SES is its volunteers. They are highly skilled and well trained to provide rescue, first aid and other services necessary in emergencies. All Units are involved in responding to the damage caused by storms, and most have an active flood management role. Ninety-one Units are responsible for road crash rescue within their own areas, and all Units provide support to other emergency services, including the Police, Fire and Ambulance services, as well as being involved in a range of community activities. Frequently, volunteers travel outside their own Unit areas at short notice and sometimes for days at a time to respond to emergency situations in other communities.

The SES performs roles including the following:
Combat agency for flood, storm and Tsunami;
Road crash rescue;
Community First Responder support for NSW Ambulance;
Land search and rescue—urban, rural and bush;
Vertical rescue;
Flood water rescue;
Maritime search and rescue;
Urban search and rescue support;
Aircraft management and co-ordination for other agencies;
Logistics and operations support for the Rural Fire Service;
Forensic evidence search and crime scene management supporting Police
Community event support;
Traffic control supporting local councils and local events;
Road closures;
Evacuations;
Liaison across all levels of the ES Sector;
Planning;
Public education;
Rescue services for domestic and native animals;
Air observation for floods and surf life saving.

Similar emergency services organisations exist in other countries. The infrastructure and organisation of personnel may not be the same and the role may vary, particularly the tasks that the emergency services of particular countries are required to perform, but all emergency services require some form of organisation and co-ordination in order to perform their roles appropriately.

Prior art systems for co-ordinating emergency services, including recording, managing and reporting on emergency activity, have generally been paper based. This leads to many problems, including, for example, duplication of reporting of an emergency incident. A person may, for example, telephone into the emergency services an incident, such as a traffic accident, and then telephone again a little later if no response has yet been made to the incident. If two separate people receive the report, the incident could be reported twice and treated as two separate incidents, resulting in over-allocation of resources to the particular incident. This was a common problem with prior art systems.

When a large emergency event has occurred, such as a storm, flood or fire affecting one or more communities, co-ordination of all response teams and allocation of resources is hampered by the prior art systems as it is virtually impossible to accurately determine the resources required for response to various multiple incidents.

Another problem with the prior art systems is that, particularly where major emergencies, such as flood, fire or storm affecting communities, occur, communications are often affected e.g. by breaking of communications lines. This also deleteriously affects recording, management and reporting of activity.

There is a need for an efficient system through which emergency communications may co-ordinate response to emergency events.

### SUMMARY OF THE INVENTION

In accordance with a first aspect, the present invention provides a system for co-ordination of remote response services, comprising a host computing system comprising a host computing system interface enabling entry of a request for assistance (RFA) and enabling allocation of a task responsive to the RFA, and a remote computing system comprising a remote computing system interface enabling entry of an RFA and enabling allocation of a task responsive to the RFA, the remote computing system comprising sufficient functionality to enable entry of an RFA and allocation of a task responsive to the RFA in the absence of any communication connection to the host computing system.

In an embodiment, the remote computing system interface presents a similar “look and feel” to the host computing system interface, giving the advantage that the same information requirements for an RFA can be easily satisfied no matter where the RFA is being entered and also requiring operators to be familiar only with one type of interface. The interfaces of the remote computing system and host computing system can be considered to be common “system interface”.

In an embodiment, there are a plurality of remote computing systems. In an embodiment, when communications are available, data may be synchronised between the host computing system and remote computing systems. In an embodiment, all RFA information entered on remote computing systems is uploaded to the host computing system during synchronisation. In an embodiment, only RFA information allocated to a particular remote computing system is downloaded from the host computing system to the remote computing system during synchronisation. Other information than RFA information may be uploaded/downloaded during synchronisation. An advantage of at least this embodiment, is that the remote computing systems only require sufficient power to enable them to deal with the information that has been allocated to them. In particular applications, therefore, the remote computing systems may be implemented by limited computer technology, e.g. by way of a laptop-type computer or personal-type computer (PC). Depending upon the amount of data the host computing system may need to process, a more powerful computing architecture can be employed here e.g. one or more server computers and computing systems supporting a database (e.g. SQL-type database).

Another advantage of at least this embodiment, is that in the event of a communications breakdown (these often occur in emergency situations) the remote computing systems still have sufficient functionality to allow entry of RFA information and allocate tasks. Emergency situations are still managed, despite the breakdown in communications. On re-establishment of communications, the system may be synchronised to ensure that all computing systems have the necessary information to enable emergency management services to be performed.

In at least this embodiment, the host computing system may have access to all the information available to the remote computing systems. Each remote computing system may be allocated particular emergency resources (including personnel and also may include equipment) to enable them to manage emergency services in a particular sector or sectors allocated to the remote computing system. The host computing system is able to manage all these sectors as it will have the information available from all the remote computing systems. A sector may be based on geographic area, personnel available or functionality. Sectors may be based on a mixture of these. Sectors may be dynamically implemented at a remote computing system level and/or host computing system level. In the case of the SES, for example, the host computing system is able to manage all sectors via the remote computing systems.

The host computing system may co-ordinate allocation of resources to sectors in response to the RFA information; remote computing systems may also allocate resources to those sectors that they are responsible for and, in an embodiment log requests for resources from other sectors and other “headquarters” Emergency services organisations may be organised into various sectors managed by “headquarters”. In the case of SES in Australia, these include a management headquarters (usually associated with the host computing system) and in this case being the State headquarters, and various Unit headquarters. Regional headquarters are provided at an intermediate level between the State headquarters and Unit headquarters. It will be appreciated that other emergency services organisations may be organised differently from this, but will still usually have a requirement for a host computing system at a management level and various remote computing systems at subsidiary levels, constituting various “headquarters”.

In an embodiment, an RFA comprises RFA data, comprising location data providing information on the location of an RFA incident, an incident data providing incident information on an RFA incident. Incident information may include a description of the type of situation e.g. “tree has fallen on a house”, “fire has damaged property”, etc. In an embodiment, the RFA data also includes priority data which designates priority status of the RFA incident. This enables an operator to make a decision as to priority of allocation of resources for responding to RFAs. In an embodiment, priority data may be set automatically depending upon RFA data.

In an embodiment, a comparison means is provided for checking and alerting for duplicate RFAs. This advantageously avoids misallocation of resources.

In an embodiment, the system also includes a Job. Register. The Job Register includes details of all jobs which arise from RFAs, and, in an embodiment, the status of those jobs (whether they have been allocated to e.g. personnel, whether they have been completed, etc). In an embodiment, the Job Register entries are also priority coded, with the same priorities allocated to the associated RFA. In an embodiment, the host computing system has access to all the Job Register entries entered by remote computing systems and by the host computing system, so that it can build an overall “picture” of the jobs required. The Job Register can be viewed via the system interface, to enable an overview of jobs required in an emergency area and control and allocation of resources. In an embodiment, the remote computing systems are only able to view via the system interface the Job Register for the jobs that have been allocated to their sector(s).

In an embodiment, the system also provides an Operations Log. The system interface enables operators to enter all activities of emergency services in the Operations Log. In an embodiment, the Operations Log includes entries of all emergency activities including, for example, weather warnings, (for example, from a weather forecasting system), information on phone calls, information on transfers between sectors, and any other information. In at least an embodiment, the Operations Log is an important reporting tool which can be used to review response to a particular emergency event by “replaying” the emergency event utilizing the information stored in the Operations Log. In an embodiment, the system interface provides an overview view of all entries in the Operations Log, the entries being selectable to “drill down” to the detail of a particular entry in the Operations Log. In an embodiment, each remote computing system and the host computing system have Operations Logs which cannot be accessed by other headquarters (for security purposes). In another embodiment the host computing system may access the Operations Logs of all remote computing systems.

In an embodiment, the system enables provision of a number of different types of report. Reporting is a requirement in most emergency services. Internal reporting may be required to ensure consistent management of emergency services. External reporting (e.g. to the government, media, etc) may also be required. In an embodiment, the system includes an Activity Report preparation means enabling preparation of Activity Reports. Information may be taken from RFAs, Operations Log, Jobs Register, etc, to build Activity Reports which can be utilised to brief officers of the emergency services.

In an embodiment, the system includes Event Reporting means enabling reporting information on an emergency Event relating to RFAs. An Event may include, for example, a particular type of environmental emergency Event (e.g. a storm Event in a particular area). RFAs relating to the storm Event, jobs relating to the storm Event can have information extracted and consolidated in order to produce an Event Report which can be used for internal and external briefings.

In an embodiment the system includes a Situation Report means enabling entry of Situation Reports. A Situation Report can be used for external and internal briefings and includes information on any particular situation that may arise from a particular RFA, or Event e.g. a Situation Report regarding a person injured in a road accident.

In an embodiment the system is arranged to interface with other systems to facilitate the provision of emergency services. In an embodiment, the system interfaces with a geo-mapping system to enable geographical information to be provided to the system. In an embodiment, maps can be produced, incorporating information on RFAs, including location information. The location of RFAs can be indicated on the map.

In an embodiment, the system is arranged to interface with a human resources system, storing information on human resources (voluntary and/or employed) which may be available to emergency services. This may be utilised to enable the system to allocate teams to various RFAs/jobs, the HR system providing all details of personnel, their location, name, etc.

In an embodiment, the system is arranged to interface with a meteorology system, enabling access to weather information.

In an embodiment, the system is arranged to enable “tagging” of RFAs for reminders to, for example, implement tasks associated with the RFA. The type of task may be a follow up task, for example. For example, dealing with an RFA will often result in some further clear up requirement after the RFA has been dealt with. Rubbish may be left, such as a chopped up tree if there has been a tree falling event on a house, for example. The tags can be used to organise follow up tasks, such as clearing of rubbish.

In at least an embodiment, a system in accordance with the present invention facilitates emergency call taking an operations management functions to enable better decisions to be made and quicker responses to emergencies.

In accordance with a second aspect, the present invention provides a remote computing system for co-ordination of remote response services, the remote computing system comprising a remote computing system interface enabling entry of a request for assistance (RFA) and enabling allocation of a task responsive to the RFA, the remote computing system comprising sufficient functionality to enable entry of an RFA and allocation of a task responsive to the RFA in the absence of any communication connection to the host computing system.

In embodiments, the remote computing system of this aspect of the invention may have any or all of the features of remote computing system of the system of the first aspect of the invention discussed above.

In accordance with third aspect, the present invention provides a system for co-ordination of remote response services, comprising a host computing system, comprising a host computing system interface enabling entry of a request for assistance (RFA) and enabling allocation of a task responsive to the RFA, and being arranged to communicate with a remote computing system, when communications are available, in order to upload/download data between the host computing system and remote computing system.

In embodiments, the host computing system of this aspect may have any or all of the features of the host computing system discussed above in relation to the first aspect of the invention.

In accordance with a fourth aspect, the present invention provides a computer programme, comprising instructions for controlling a computer to implement a system in accordance with the first aspect of the invention.

In accordance with a fifth aspect, the present invention provides a computer readable medium providing a computer programme in accordance with the fourth aspect.

In accordance with a sixth aspect, the present invention provides a computer programme comprising instructions for controlling a computer to implement a system in accordance with the second aspect of the invention.

In accordance with a seventh aspect, the present invention provides a computer readable medium providing a computer programme in accordance with the sixth aspect.

In accordance with an eighth aspect, the present invention provides a computer programme, comprising instructions for controlling a computer to implement a system in accordance with the third aspect of the invention.

In accordance with a ninth aspect, the present invention provides a computer readable medium providing a computer programme in accordance with the eighth aspect.

In accordance with a tenth aspect, the present invention provides a method for co-ordination of remote response services, comprising the steps of an operator entering details of a Request For Assistance (RFA) and allocating a task responsive to the RFA, utilizing the system in accordance with either the first, second or third aspects of the invention.

In accordance with an eleventh aspect, the present invention provides a system for co-ordination of remote response services, comprising a computing system, comprising a computing system interface enabling entry of a Request for Assistance (RFA) and enabling allocation of a task responsive to the RFA.

The RFA may comprise RFA data, comprising location data providing information on the location of an RFA incident, and incident data, providing incident information on an RFA incident. The RFA data may further comprise priority data, providing information on a priority status of the RFA incident. The system may be arranged to automatically set the priority data in response to the RFA incident data. In an embodiment, an operator may be able to set the priority data.

In an embodiment, the system is arranged to compare RFAs already entered into the system, and provide an alert if it considers that there may be a duplicate entry.

In an embodiment, the system includes a Job Register, the Job Register comprising Job Register data comprising information on the status of RFAs.

In an embodiment, the system enables designation of a task and allocation of resources to the task, for dealing with an RFA.

In an embodiment, the system enables logging the transfer of resources for dealing with RFAs.

In an embodiment, the computing system is arranged to synchronise with other computing systems, in order to exchange information on RFAs. Other information may also be exchanged.

In an embodiment, the system enables “tagging” information to be included associated with an RFA, for providing alerts in relation to tasks associated with RFA. The associated tasks may include follow up tasks, such as a follow up to collect rubbish that may be left over from processing of an RFA. The system is preferably arranged to implement a search function to search for tasks in order to consolidate follow up tasks.

In an embodiment, the system is arranged to enable the preparation of a Situation Report, Situation Reports including information on response situations.

In an embodiment, the system is arranged to enable preparation of Activity Reports, arranged to utilise information from RFAs to build Activity Reports.

In an embodiment, the system is arranged to enable preparation of Event Reports, enabling presentation of information on emergency Events relating to RFAs.

In an embodiment, the system is arranged to interface with other systems. The systems may include a geo-mapping system, and/or a human resources system and/or a meteorology system.

In emergencies and environmental disaster communications often break down. An architecture which enables a remote computing system to have sufficient functionality to perform a disaster recovery task without connection to a host system is advantageous.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic block diagram of a system in accordance with an embodiment of the present invention;

FIGS. 2a to 2f are representations of graphical user interface (GUI) “screen shots” of a system interface, illustrating various stages in data entry for a Request For Assistance (RFA);

FIGS. 3a to 3c are representations of GUI screen shots illustrating selection and monitoring of team personnel resources;

FIGS. 4a and 4b are GUI screen shots illustrating an interface for enabling entry of a Situation Report;

FIGS. 5a and 5b are GUI screen shots illustrating how an Event may be recorded on the system;

FIGS. 6a and 6b are GUI screen shots illustrating how an Activity Report may be entered on the system;

FIG. 7 is a GUI screen shot illustrating an example Job Register showing registered job information;

FIG. 8 is a GUI screen shot illustrating a sample Operations Log showing entered operations log information;

FIGS. 9a and 9b are screen shots illustrating an exporting operation of extracts from a Job Register into Excel™;

FIG. 10 is a GUI screen shot of a system interface showing a number of custom tagged entries for facilitating follow up action;

FIG. 11 is a GUI screen shot of an example map produced by the system showing location of RFAs and other information;

FIG. 12 is a GUI screen shot showing a further map showing location of RFAs;

FIG. 13 is a GUI screen shot illustrating other functionality of the system;

FIG. 14 is a GUI screen shot showing a management console view which may be provided by the system;

FIGS. 15a to 15c are GUI screen shots showing Task Screens provided by the system of this embodiment;

FIGS. 16a to 16g are GUI screen shots illustrating example entry of an RFA; and

FIGS. 17a to 17e are GUI screen shots of the system interface illustrating management of Sectors.

### DETAILED DESCRIPTION OF EMBODIMENTS

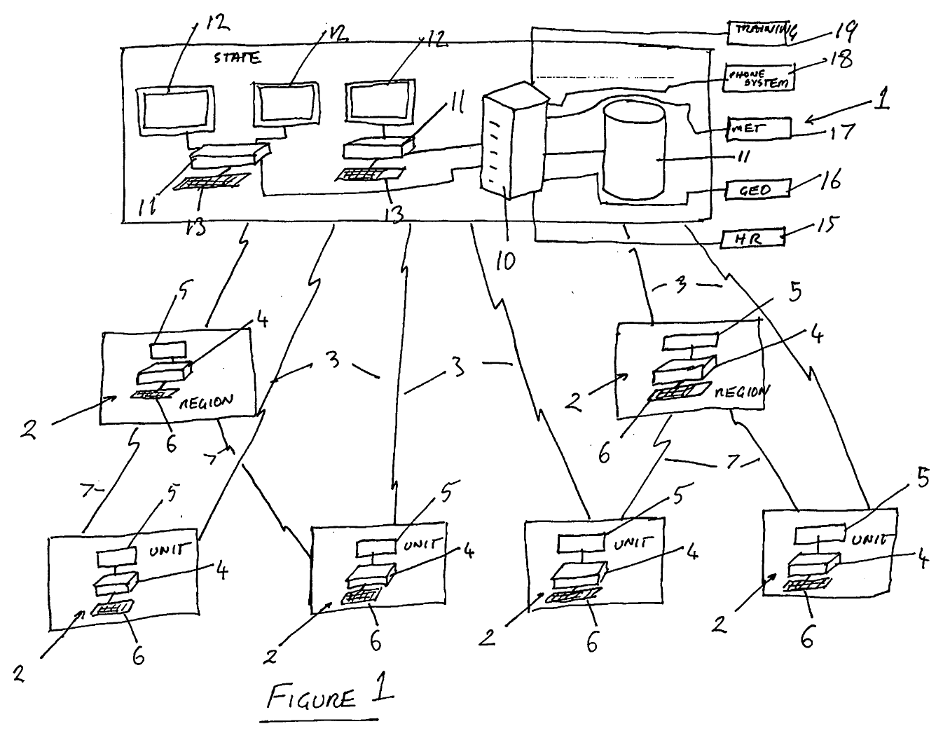

FIG. 1 schematically illustrates a system for facilitating co-ordinating of remote response services, in accordance with an embodiment of the present invention. The system includes a host computing system, generally designated by reference numeral 1, and a plurality of remote computing systems 2. Each of the computing systems 1, 2 in this embodiment, enables an operator to enter a Request For Assistance (RFA). An RFA is a term which is intended to identify the concept of an incident which requires a response by response services. For example, the incident may be an emergency incident which requires services personnel to attend in order to deal with the emergency incident. The term RFA is intended to include any type of request for assistance (and is not limited to the particular terminology “Request for Assistance”—other embodiments of the system may utilise different terminology from this, but the concept will generally be the same).

In this embodiment, the host computing system 1 and remote computing systems 2, separately have sufficient functionality to enable entry of an RFA and allocation of a task responsive to the RFA, even where there is no communication between the host computing system 1 and remote computing systems 2. The remote computing systems 2 have sufficient functionality to enable operation when they are not in communication with the host system 1, in order to be able to continue taking the RFAs and entering tasks that need to be carried to respond to the RFAs. In emergency systems, as discussed above, communications often fail. This functionality is therefore required of the remote computing systems 2, as well as the host computing system 1. In this embodiment, the remote computing systems 2 essentially operate as “smart clients”. They include sufficient software and memory to run sufficient program functionality and data storage to enable RFAs to be input and stored and responded to as discussed in more detail in the following description.

In this embodiment, when communications 3 are available between the host computing system 1 and remote computing system 2, data synchronisation is implemented. RFA data (and other data in this embodiment, to be described later) are exchanged between the host computing system 1 and remote computing system 2. In this way the entire system can be kept up to date and the host computing system 1 is aware of RFA information entered by the remote computing systems 2.

In this embodiment, synchronisation information from the host computing system 1 is only provided on a “need to know” basis. That is, RFA information (and other information) is downloaded only to the remote computing systems 2 that needs to know about the RFA information (perhaps because the area that remote computing unit 2 is responsible for is where the RFA has occurred). If necessary, RFA information from other areas can be transferred to a particular remote computing system 2, but generally the remote computing unit 2 will not need to be aware of RFA information for the entire area covered by the host computing system 1. The remote computing systems 2, need not be of great capacity. In many cases, a simple PC and operating system will suffice for the remote computing systems 2. It will be appreciated, however, that the present invention is not limited to the remote computing systems being PCs, and that they could be any type of convenient hardware/software infrastructure, including laptops (potentially handhelds and other types of computing hardware/software arrangement). In the example embodiment of FIG. 1, the remote computing systems 2 are PCs 4 including VDU 5, keyboard 6 and other interface devices, such as a mouse (not shown) as may be required to interface with the PC 4. Remote computing systems 2 therefore have sufficient functionality to deal with the tasks required of them for their particular area, including entering and responding to RFAs.

In this particular embodiment, the remote computing systems 2 have been designated for operation by Units and Regions within the State Emergency Service (SES) of New South Wales, Australia. Each Unit's remote computing system is tasked with dealing with RFAs in the area or “Sector” that that particular Unit is responsible for. As discussed above, a number of Units may fall within a Region, and each Region will have a remote computing system 2 responsible for that Region. There may or may not be communications 7 between the Regional computing systems 2 and Unit computing systems 2. In one embodiment, communications are all via the host computing system 1.

In the system of this embodiment, the default is that each Unit becomes a Sector. As will be described later on, however, Units may define their own Sectors (as geographical, available personnel, types of task, etc). This definition of Sectors may then be uploaded to the host computing system 1, so that the host computing system 1 is aware. Similarly the host computing system 1 may define Sectors and download those Sectors to the remote computing units 2.

In this embodiment, the host computing system 1 includes a server 10 and a database 11 for storing data relating to RFAs and other information required by the system. It also includes computing devices (which may be PCs 11) connected to the server computer 10. VDUs (which in this case at State headquarters may be large screens) 12 for displaying information provided and also input interfaces 13 which may include keyboards, mice and other interface devices. The host computing system 1 is not limited to the architecture shown, and any other convenient hardware/software architecture that performs the functionality of this embodiment as described later may be utilised, including a client/server architecture or a terminal/mainframe architecture, or any other architecture.

The host computing system 1 is, in this embodiment, enabled to co-ordinate activities across all the Regions and Units (and their respective remote computing systems 2) as, when communications occur, it is arranged to receive all the information from the remote computing systems 2 that is relevant to its role.

In this embodiment, the host computing system 1 also interfaces with a human resources system 15, which includes information on human resources available to the emergency service; a geo-mapping system 16 (in this embodiment being ESRI™) which enables the generation of maps utilizing the system data; a meteorology system 17 enabling inputting of information on weather and the environment; a phone system 18 enabling detection and information about number and location of phone calls, and a training system 19 enabling aspects of the system for co-ordination of remote response services to be used in training.

An advantage of the distributed computing model is that the system harnesses the processing power of individual computers, thus minimising the volume of information that needs to be exchanged during communications. Although in this embodiment all RFA information is stored at the host computing system 1, only RFA information for a particular Region or Unit is required to be stored on a particular Region or Unit's computing system. This has the further advantage that if the host computing system should lose data, it can reproduce it by obtaining it from the Regions and Units computing systems 2.

The system is arranged to work on minimum infrastructure, in this embodiment being Windows 98® and a 33 kb dial up Internet connection (very useful where communications to remote regions are difficult). The storing of information locally enables management of operation of a emergency service operation to continue if no connectivity is available.

The system of this embodiment includes the following technical features:

The remote computing systems 2 are based on Windows®, Smart Client®, and have been built using Microsoft® technology.

Security features include:
Encryption client file
Client/server data communication use security tokens
Data transfer in binary (not in clear text, which means less data transfer compared to XML).

The technology is scalable. Multiple servers may be added and new remote computing systems may be incorporated.

In this embodiment, the system has been divided into State, Region and Unit. It will be appreciated that in other embodiments, this division may not be required. Other emergency service systems may have other hierarchical (or non-hierarchical structures) and the present invention may be adapted to those other structures. The system will still require a host computing system 1 and remote computing system 2.

In this embodiment, the interface presented on the remote computing system corresponds generally to the “look and feel” of the interface provided by the host computing system. This minimises training requirements and also ensures that the information required for an RFA and other aspects of the system is conveniently entered using either a remote computing system or host computing system.

Requests For Assistance (RFA) are devices which are used by the system in order to track emergency incidents and ensure that emergency incidents are responded to. RFAs must include the necessary information on the incident to enable it to be responded to. In this embodiment, each RFA comprises RFA data which includes location data and incident data. Location data provides sufficient information to enable the location of the incident to be located. The incident data provides enough of a description of the incident to enable a reasonable response to be formulated.

In this embodiment, an RFA is entered by way of a user interface which is available in the remote computing systems 2 and host computing system 1. Information requiring an RFA may reach the system in a number of ways:
Telephone call to a remote Unit, a Regional unit or the host system. In New South Wales an emergency telephone connection is governed by phone system 18 which enables lines to be re-routed when necessary (for example, when a disaster in a particular area is occurring, it may be necessary to re-route lines to ensure that all telephone calls are answered). The call may be from a person who is being affected by an incident.
A call or communication from other emergency services personnel e.g. police force or ambulance.
A call from a volunteer or other systems personnel who has become aware of an incident, or entry of an RFA by that person.
A call placed to other emergency services e.g. police or ambulance, may be re-routed to the host computing system 1.

There are a number of other ways that information requiring an RFA may reach the system.

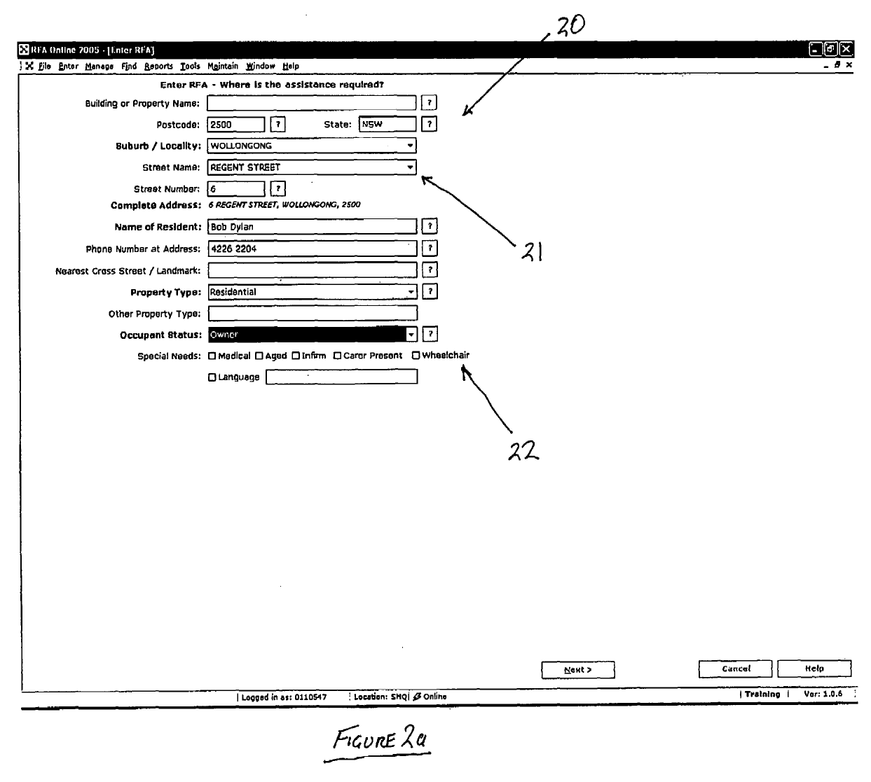

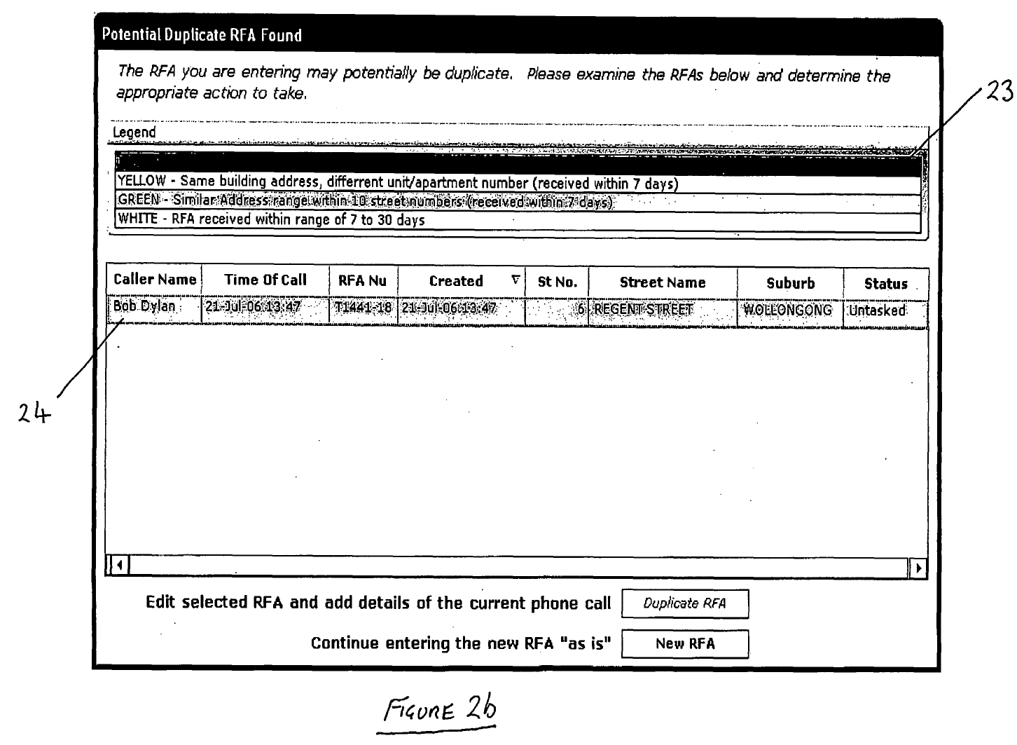

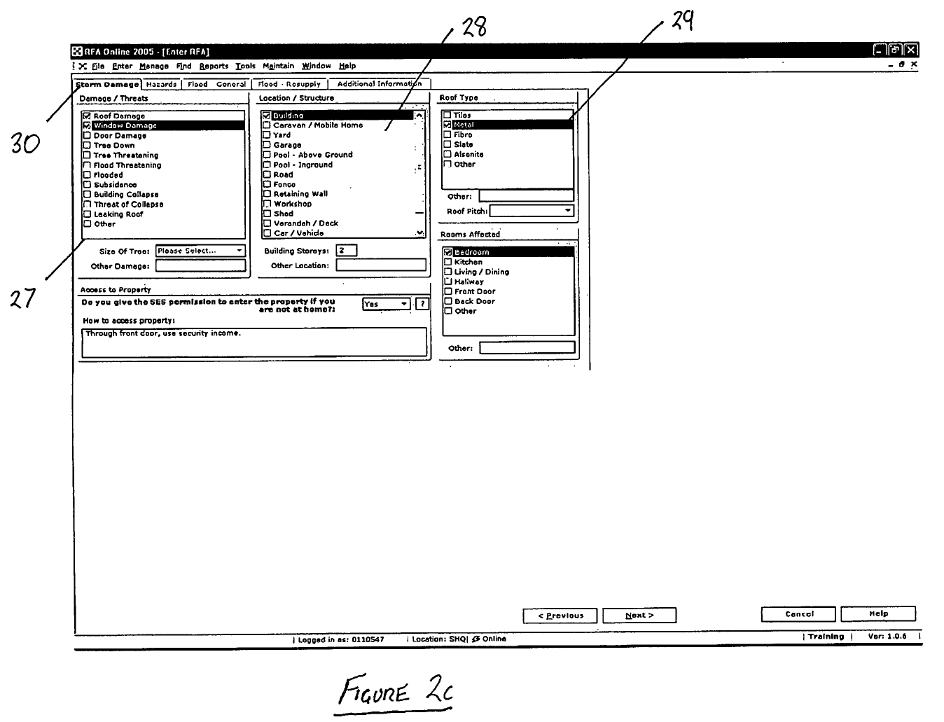

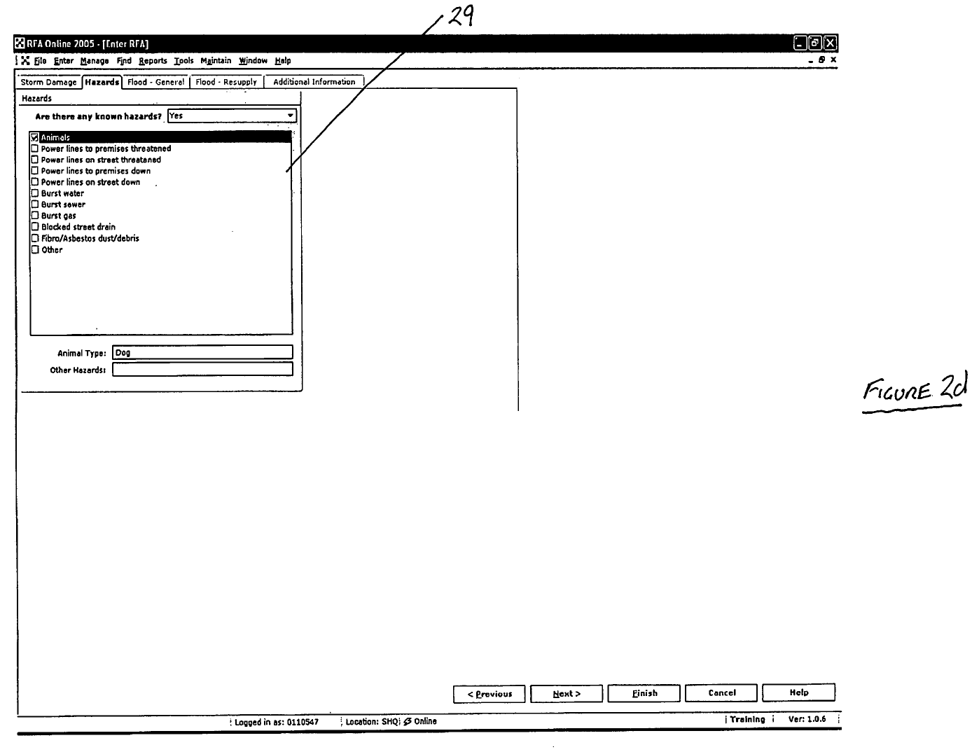

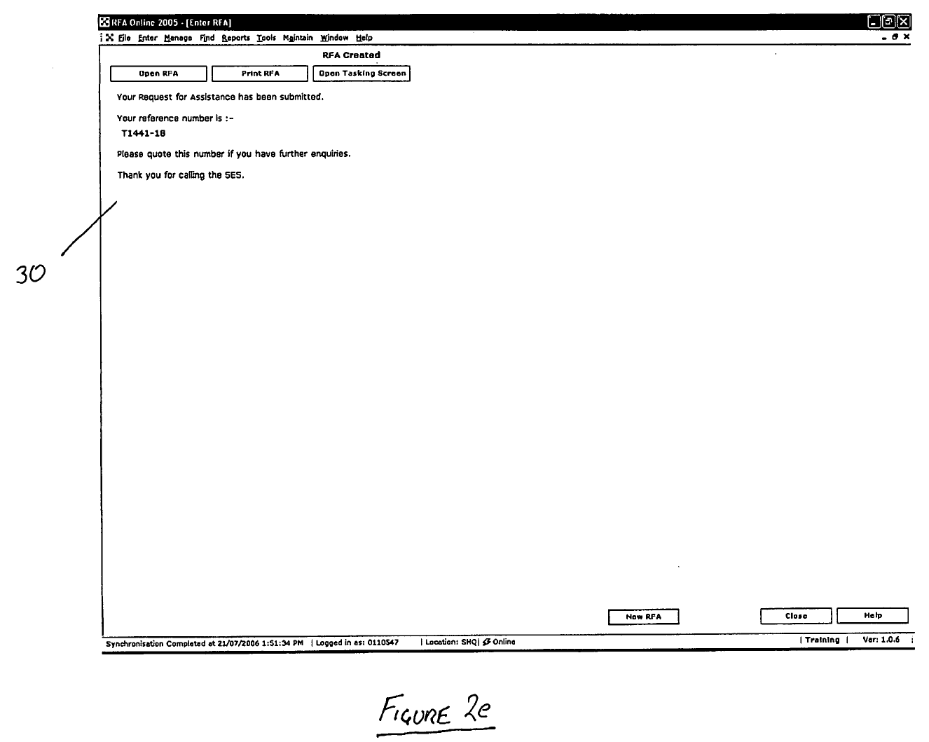

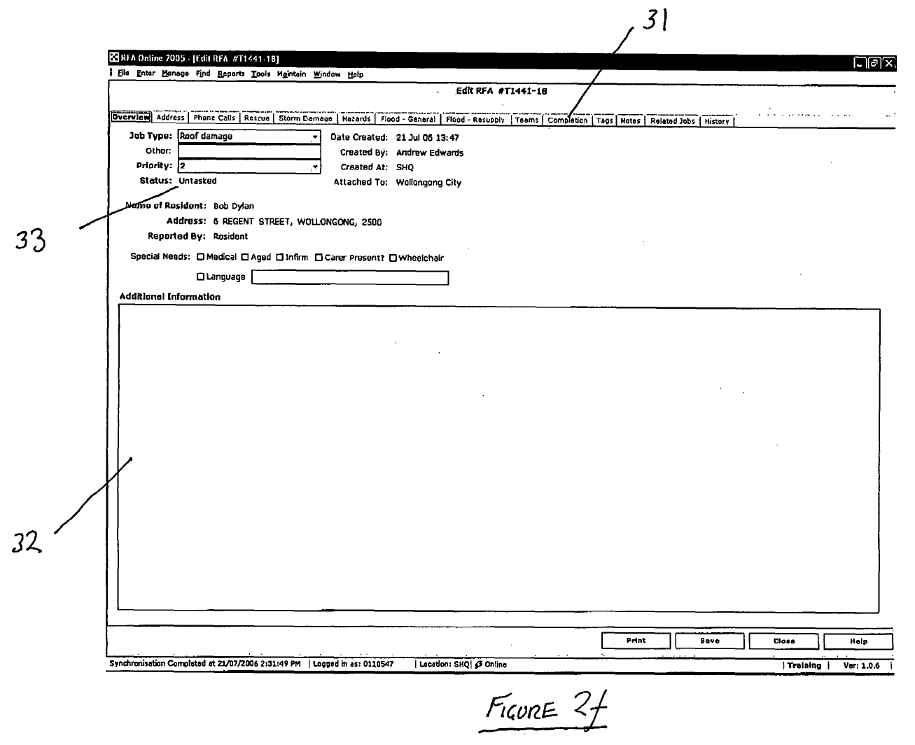

Entry of an RFA will now be described with reference to FIGS. 2a through to 2e.

Once an RFA has been entered, all the data that is available to be used throughout the system in other system devices, such as the operations log, the Jobs Register, for graphical analysis of emergencies, and for other devices. The data may be distributed to appropriate remote Regions and Units according to the host system 1 and/or provided to the host system 1 from remote Units/Regions when communications are available.

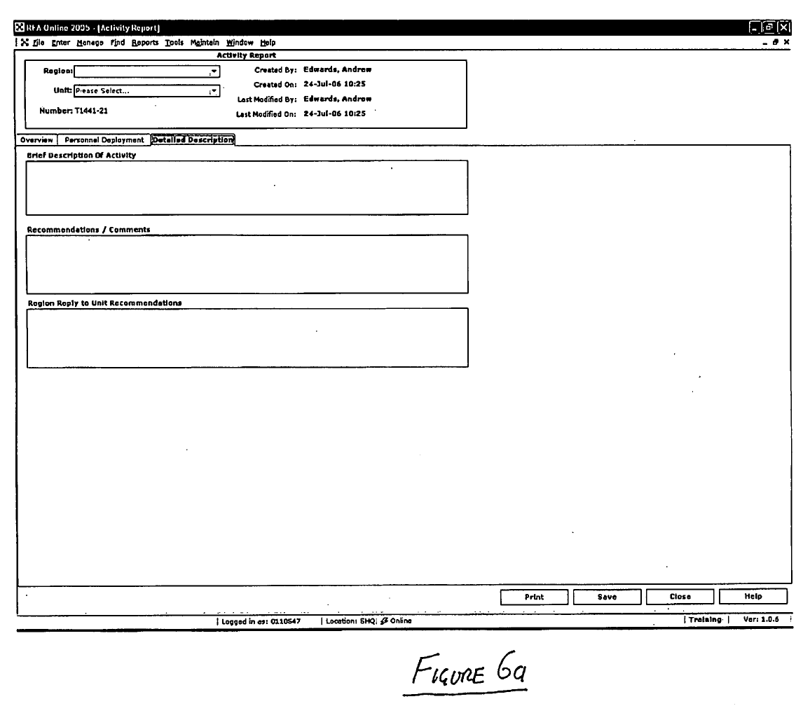

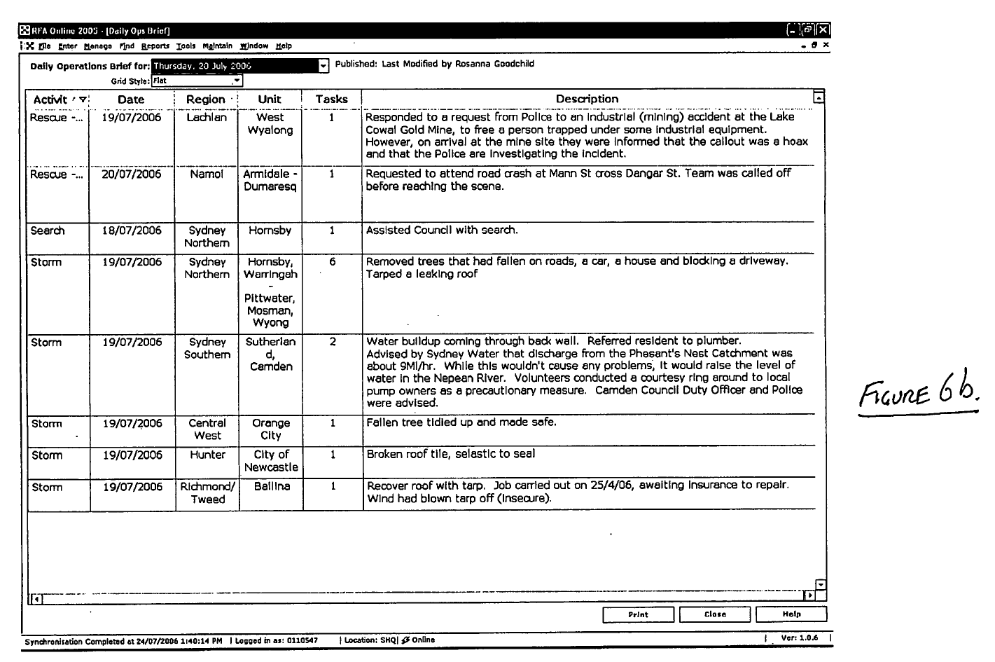

As can be seen from FIG. 2a through to FIG. 6, data entry is via text and check boxes and other usual GUI tools. A guiding “Wizard” is used to enable operators at all levels to enter the correct data. There is extensive use of contextual menus to facilitate entry of RFAs (and other information required by other devices in the system).

In this embodiment, as illustrated in FIG. 2a, a menu 20 prompts entry of location information of the RFA. This is essentially done in reverse to usual order (normally one would ask for the person's name first for entry, but in this case the person's Building or Property name is requested followed by the Postcode of the area). In the example of FIG. 2a, the Postcode has been filled in first (no Building or Property name available). As discussed above, the system is interfaced with a geo-mapping system. Entry of the Postcode prompts the mapping system to provide appropriate data to the RFA wizard menu 20. Drop down menus are available for each of the fields 21 requiring an entry. Once the system is aware of the Postcode, the Suburb drop down menu will provide a list of suburbs which correspond with the Postcode. Once the suburb is selected, the drop down menu for Street Name will provide a list of streets which are available in that suburb. This is a simple way to guide the user through entry of location information. Where an item does not appear in the drop down menu, the user can enter text themselves.

There is also a Special Needs section 22 of the menu which enables checking of items to indicate that special needs are required by people at that location. This provides an alert for the type of resources that will be required to attend at that location. For example, special needs include Medical, Aged, Infirm, Carer Present, Wheelchair, and there may be many others.

One of the features of the system of this embodiment is the ability to check for duplicate entries. Referring to FIG. 2b, once a location entry for an RFA location has been made, the system then runs a check on the available data to see if it is a potentially duplicate entry. Not only an exact match is checked for, but also similar and potentially duplicate matches as illustrated in FIG. 2b, reference numeral 23. Types of matches are colour coded:
Red—an exact address match (received within 7 days)
Yellow—same building address, different unit/apartment number (received within 7 days)
Green—similar address range within 10 street numbers (received within 7 days)
White—RFA received within range of 7 to 30 days.

An operator can use this colour coding to determine whether they may have a duplicate entry e.g. they may have another person from a similar location calling in to report what is essentially the same disaster event. If they do determine that there is a duplicate event, then they can allocate resources appropriately (i.e. they won't send more people if people have already been despatched to deal with the event).

In the example of FIG. 2b, the RFA being entered is colour coded Green 24 to indicate that the operator needs to determine whether or not there is a potential duplicate.

Caller details, if they are different from the property owner are also collected 25.

Referring to FIG. 2c, various check boxes are enabled to obtain information about the RFA incident and, in particular, what location/structure may be encountered. Information is also requested regarding the location/structure 28 and type of roof 29 if the problem is with a roof. The system may incorporate features for any types of emergency likely to be encountered. The screen shown is for storm damage 30. There are other screens for other types of damage, as indicated.

Details of hazards that may be encountered are given in screen 29 in FIG. 2d. Again there may be any number of hazards. On completion of an entry a unique identifier 30, FIG. 2e is assigned to the request. The request is then viewed and edited with the information structured in tabs across the top of the screen 31, FIG. 2f.

The information entered for an RFA can then be used throughout the system, as discussed above.

Note that a field is provided 32 for additional information to be entered.

Each RFA can be allocated a priority level. This can be done by the operator and it can also be done automatically. For example if the situation is a “life threatening” situation (there is a check box available for this) the priority level will be 1 (colour coded Red). The system is also arranged to enable the operator to select other degrees of priority. This allows them to classify their RFAs. All RFAs will appear in the Job Register (see later). The colour coding allows for prioritising tasks required to respond to the RFAs.

Once an RFA has been entered, it will then be “Tasked”. Tasking will usually be by allocating the RFA to a Team for the Team to deal with the RFA. Teams may be formed by the operator of the system or may be already formed and selected by the operator of the system. Team selection may be over-ridden by the operator. Once an RFA is tasked the RFA will be status updated as “Tasked” (reference numeral 33, FIG. 2f).

Once a Team has been selected with the appropriate resources to carry out the Task, the team must be contacted. The system provides an alert advising the operator that they need to “message” the Team leader or other Team members. This can be done by any communication means (in an emergency not all communication lines may remain open) such as text messaging, telephone calls, mobile telephone calls, etc. The operator must clear the alert once the Team has been notified.

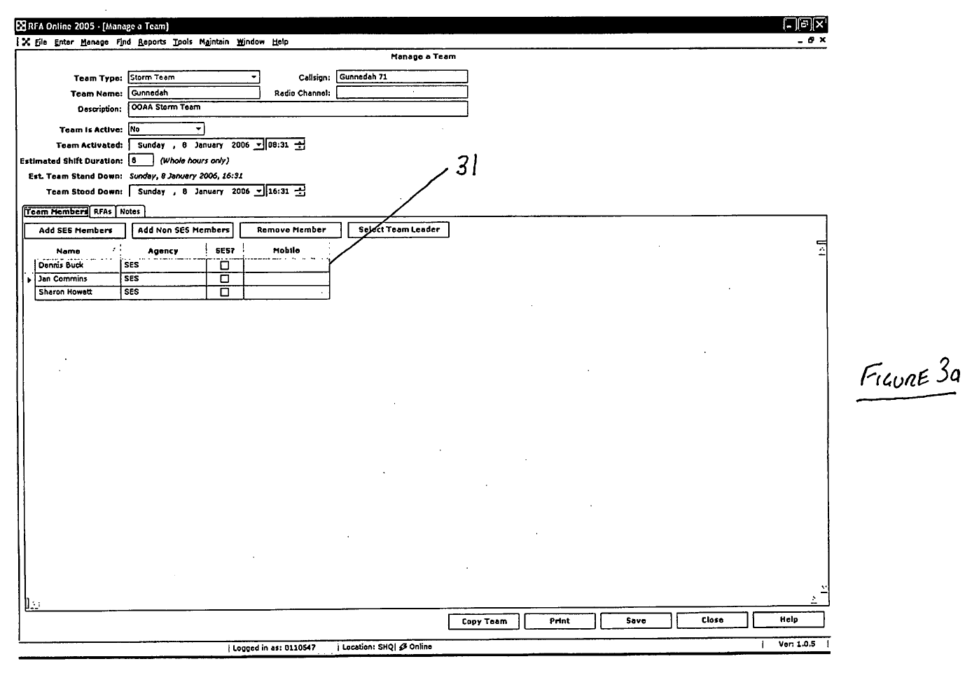

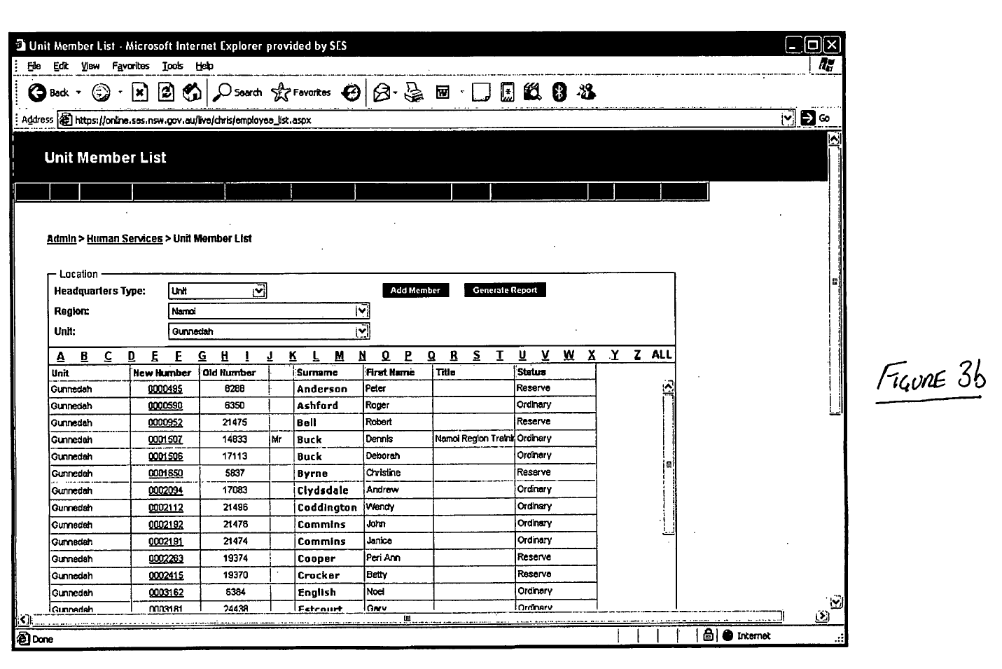

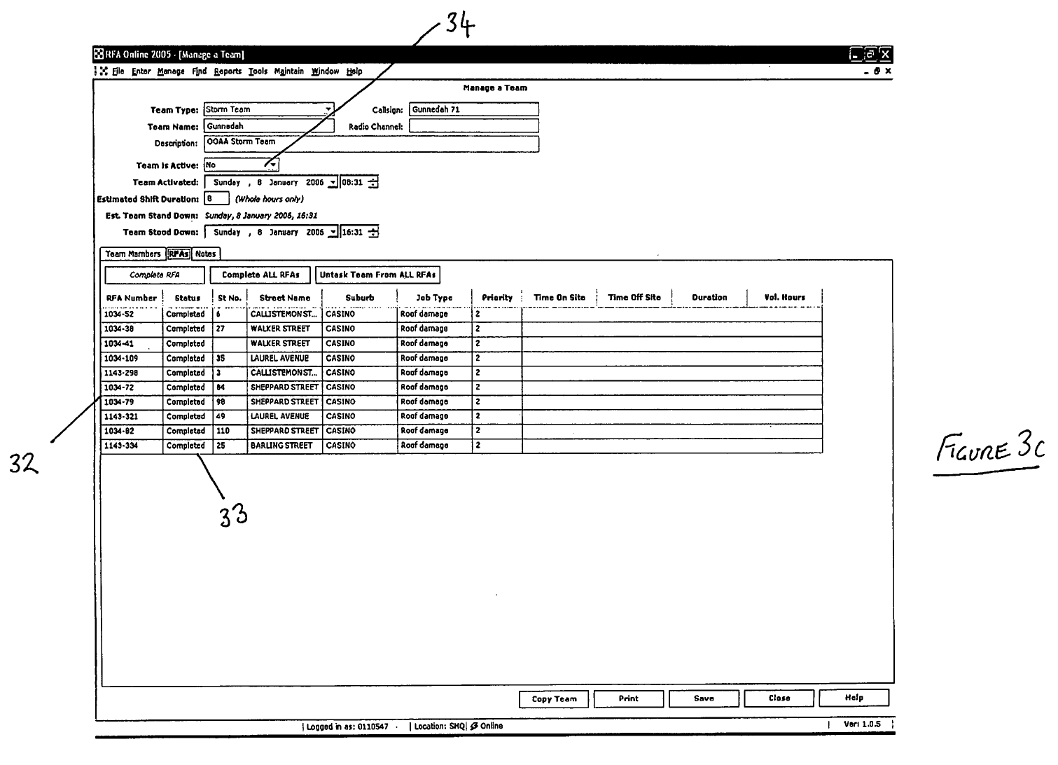

FIGS. 3a through 3c show screens which guide a user in selecting Teams and allocating Tasks to the teams. Team Management functionality makes it easy to create Teams, transfer them between Headquarters (Units, Regions or States) identify start and stand down times, identify the jobs they are working on to also add non SES members to teams. Team Leaders are easily identifiable, highlighted in Yellow (reference numeral 31, FIG. 3a). It can be seen from FIG. 3 that various data is available (Team Data) about the activity of the Team, the time it is available to do work, whether the Team is active or not, etc.

As discussed above, the system is integrated with the human resources of the SES (reference numeral 15 in FIG. 1). All volunteers and SES members are therefore available to the system for utilisation with the Team Data. See FIG. 3b which is an extract from the Unit Member List of Gulladela.

FIG. 3c illustrates some of the power of the system. At a touch of the button it is possible to obtain a list of all the RFAs that a particular Team has been tasked with, reference numeral 32. In this case it can be seen that all the Tasks have been completed (reference numeral 33) and the Team is not active (reference numeral 34). Teams can also be transferred between headquarters using this system.

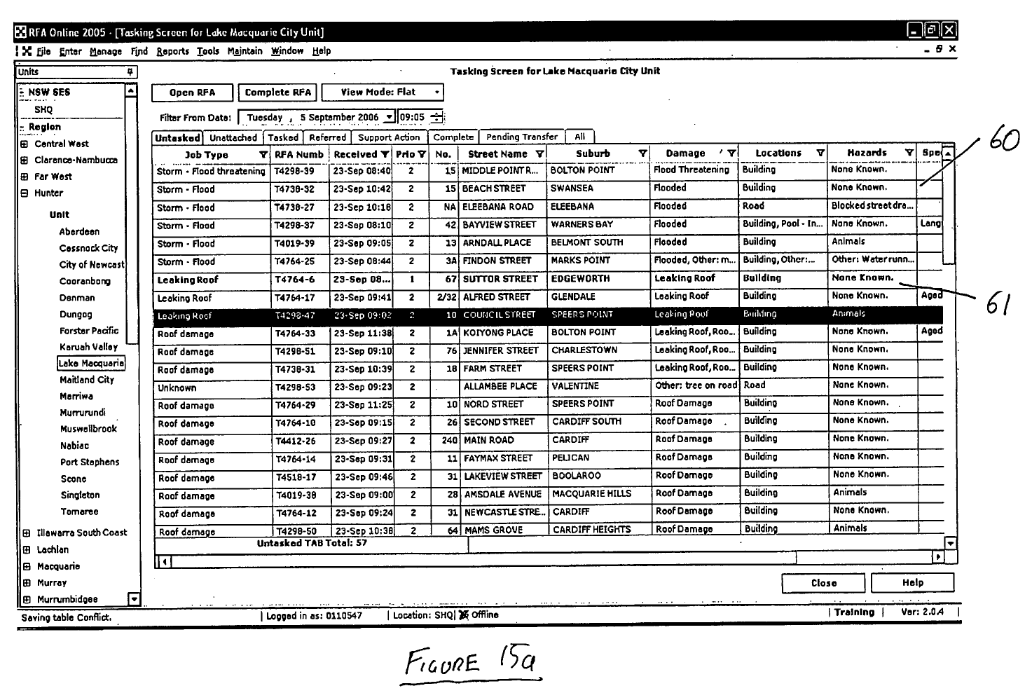

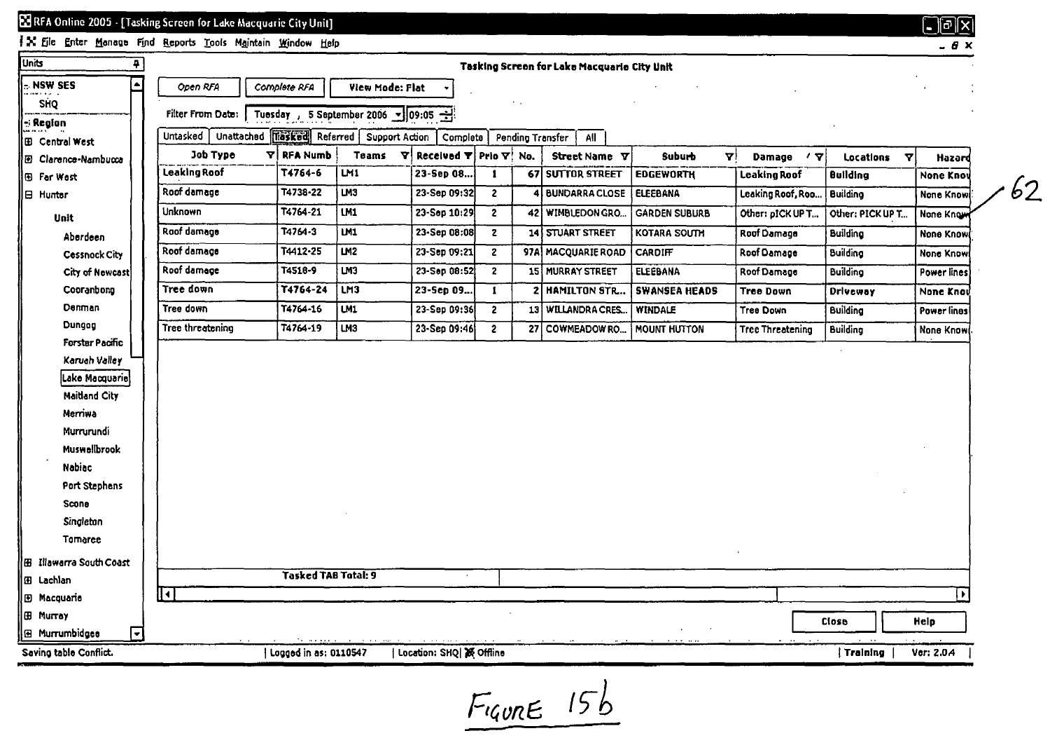

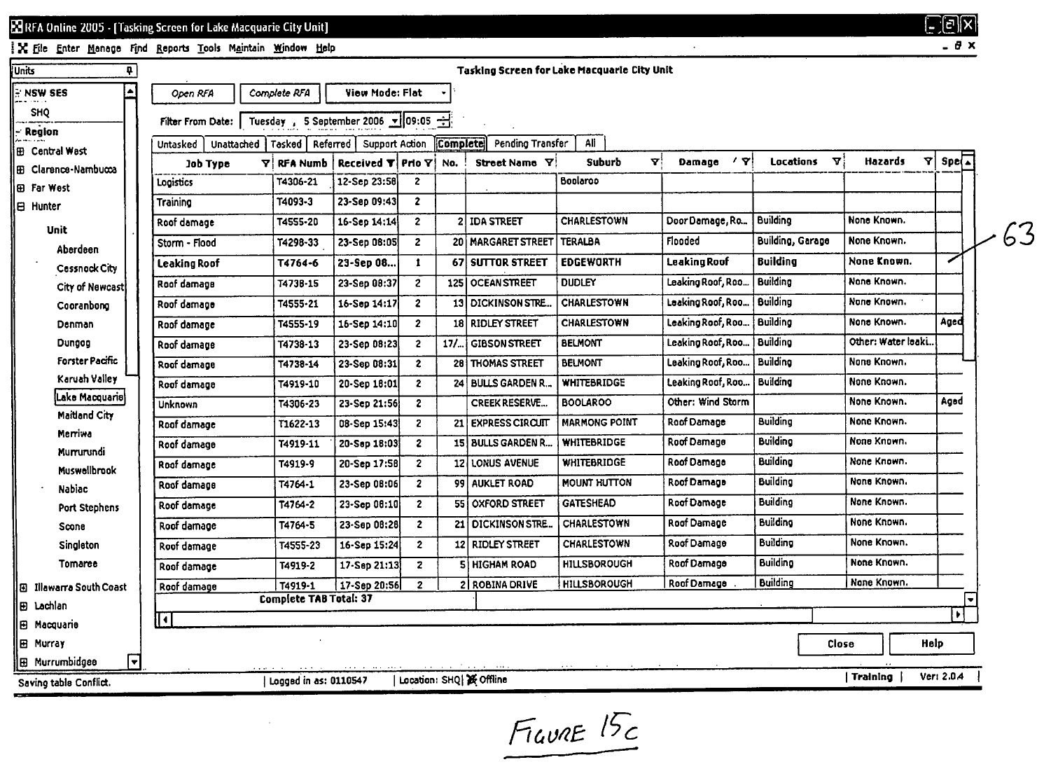

A Tasking screen is illustrated in FIG. 15a. Reference numeral 60 illustrates a list of tasks that have not yet been allocated (“Untasked”). Reference numeral 61 shows a highlighted (in red) “priority one” task. The Task screen may be accessed once a RFA has been entered, from the RFA interface.

Once a job has been tasked, it moves to the Task screen, reference numeral 62, FIG. 15b. On completion of a task, it is moved to the Completed tab (reference numeral 63 FIG. 15c).

One of the important requirements of the system is to be able to provide reports of emergency situations e.g. for internal use for controlling operations and also, for example, for external use e.g. the media.

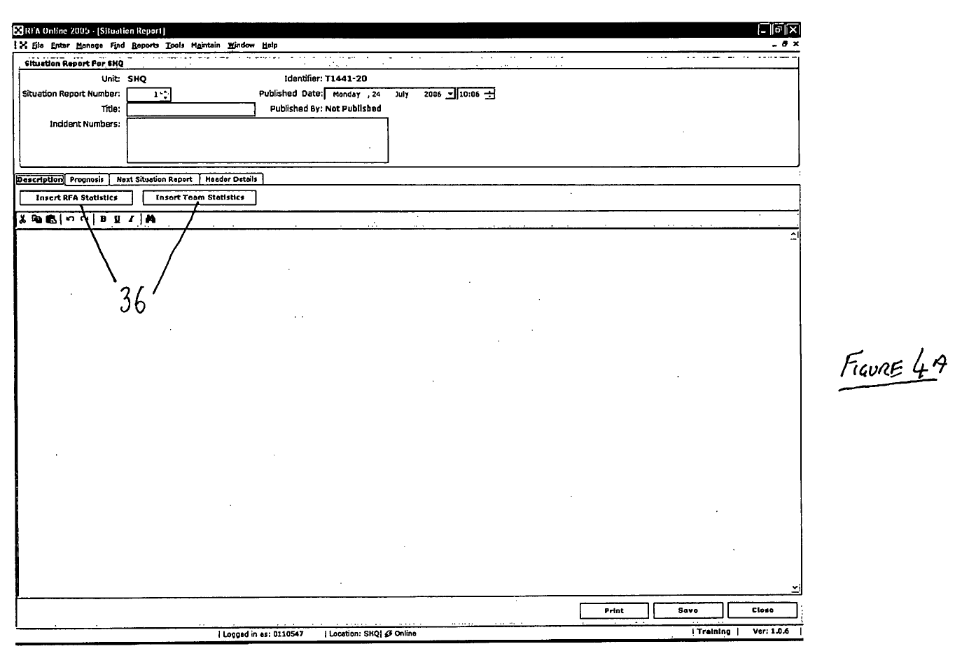

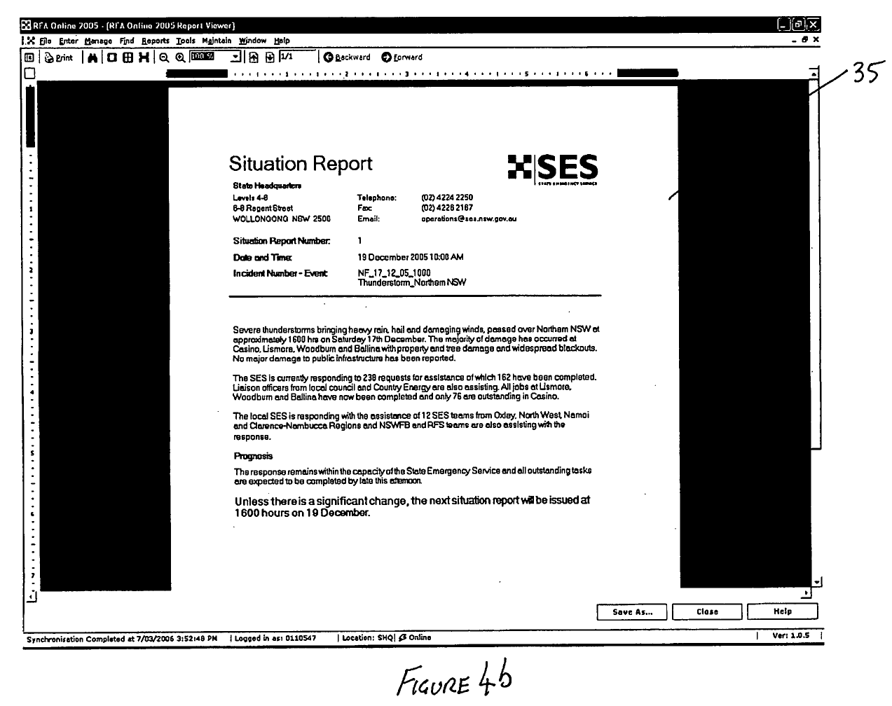

FIGS. 4a and 4b illustrate a system interface which enables an operator to enter a Situation Report. These pre-defined templates are provided to guide Situation Reports, and text can be added using word processing functionality. An example Situation Report is shown at reference numeral 35 in FIG. 4b. Situation Reports can be transmitted across the system. Statistics from Events can be included at the click of a button. Reference numeral 36 FIG. 4. This is another example of how information can be taken in once (via an RFA) and used multiple times in this system.

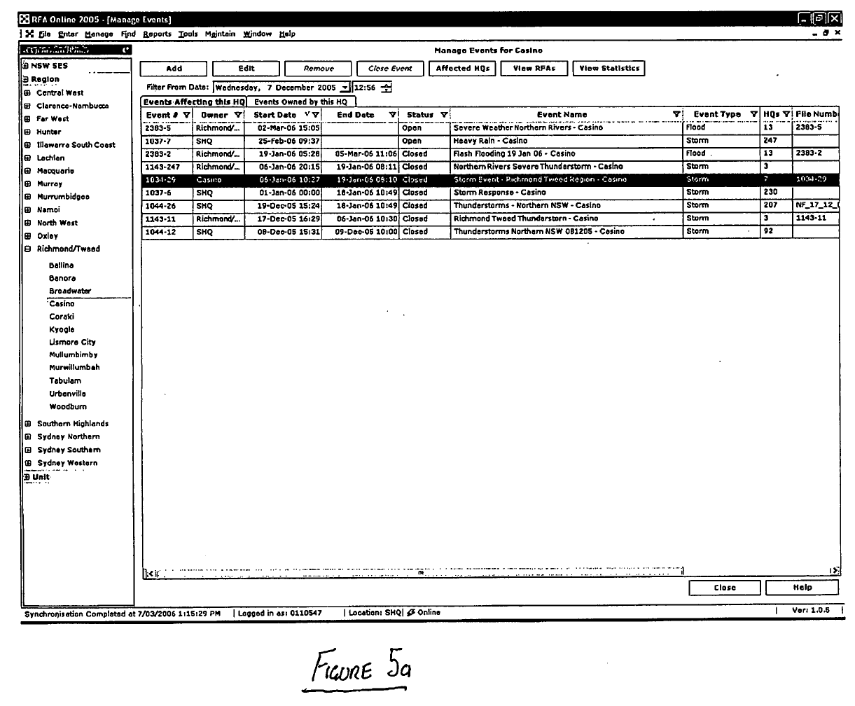

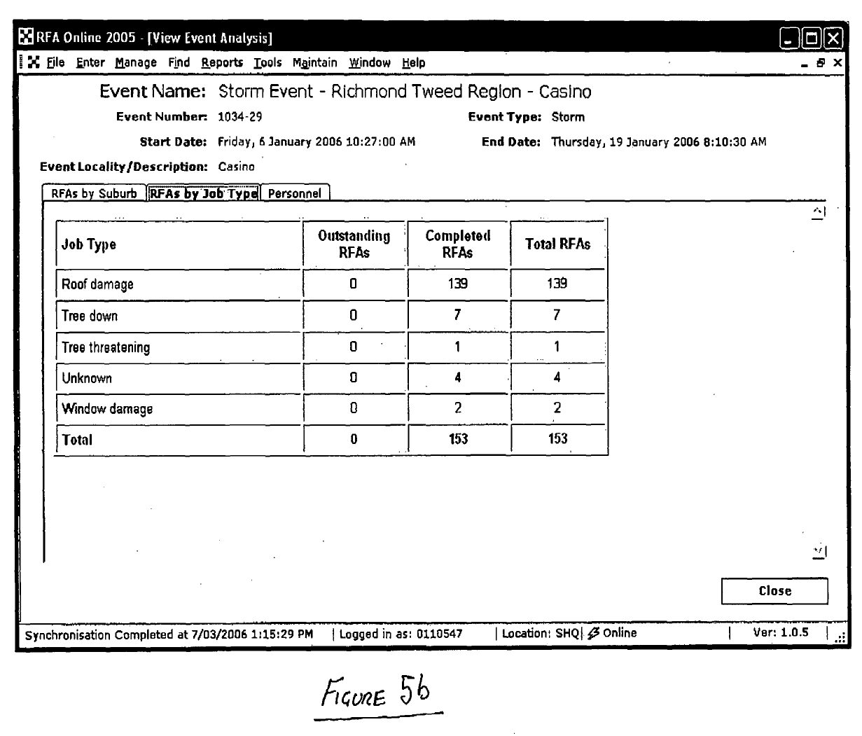

Operators are also able to create Events—that is a set of parameters that enable information to be reported consistently throughout the system. See FIGS. 5a and 5b. Events can be created at any level of the system (Unit, Region, Host) and can be based on geographic location or functional requirements. Higher headquarters can roll lower headquarters Events up to ensure consistency in reporting. The example of FIG. 5a shows an event in Casino which is a storm Event affecting seven headquarters. Users can include or exclude different jobs from an Event based on geographic location function and summary information at the click of a button. See FIG. 5a which is Summary Information of the types of RFAs that were responded to. Again, this shows taking information in once and using it multiple times. Events are very useful for reporting State wide.

Another reporting function of the system is implemented by the User Activity Reports, see FIGS. 6a and 6b. Activity Reports can be billed from selected Jobs. They can be used to report to internal SES executives or externally. In the SES, Activity Reports are used to report on all activities that have been undertaken during the previous 24 hours. Once published an Activity Report is available to be viewed or printed.

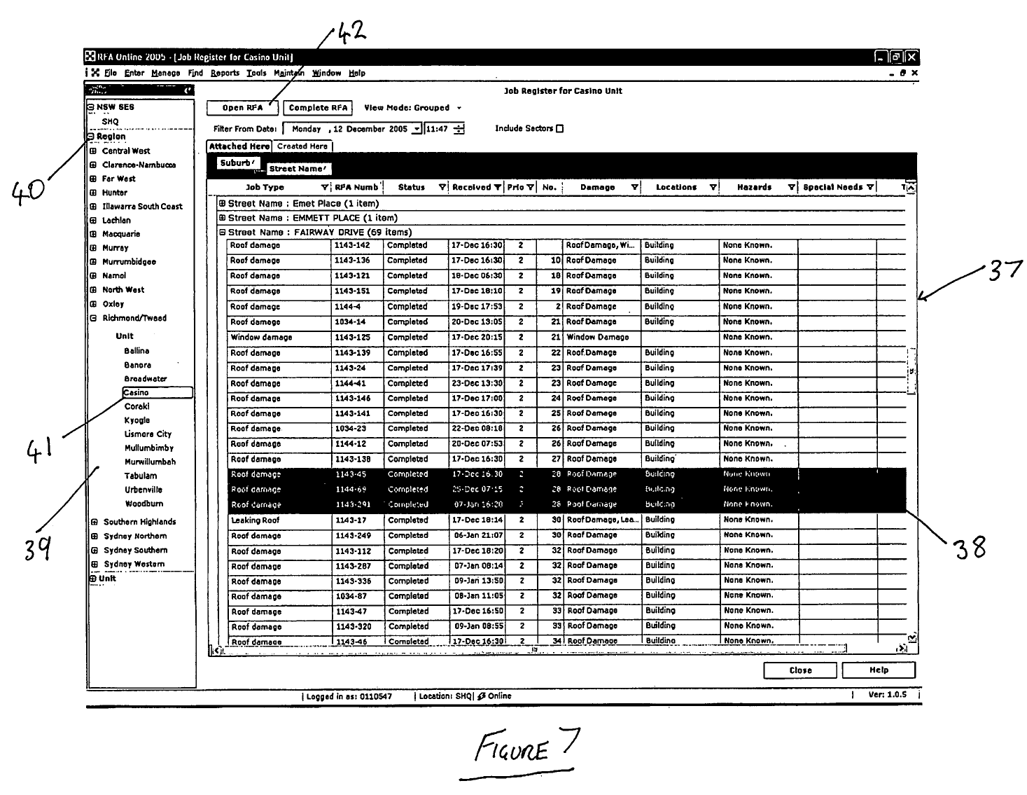

A further feature of the system is the Job Register. Referring to FIG. 7, the Job Register, reference numeral 37 is in the form of an Excel™ type grid which is used throughout the system to enable the users to group and sort jobs simply and easily. The Job Register provides the user with an overview of all jobs, their type and status. Jobs may be colour coded to highlight various features. Reference numeral 38 indicates jobs colour coded to identify the same premises that suffered storm damage on three separate occasions. Data from RFAs are automatically imported into the Job Register and the Job Register can be used to monitor the resources required for deployment to particular locations in order to complete jobs. This means that human material resources can be utilised much more efficiently, the Jobs Register providing a total easy to read “overview” enabling an estimation of the human and material resources required in a particular area.

On the left hand side of the display, reference numeral 39, a list of locations in the system geographic area are provided. Clicking on one of these locations drops down a list of Units within the particular area (Region 40 in this case). Highlighting (reference numeral 41) one of these regions gives the Job Register for that Region. In this case the Jobs Register for Casino is given. RFAs can be accessed via the Jobs Register (highlighting and clicking on Open RFA reference numeral 42). The Jobs Register Data that is viewable depends upon the hierarchy of the computing system within the system. The host computing system 1 has available to it all the Jobs Registers from all the remote computing systems 2 in a consolidated Jobs Register. This enables the State management to view immediately what resources may be required in what geographical areas of the State. Lower down the hierarchy, the Jobs Register allocated only to those Units/Regions may be viewed. Note that jobs may be transferred between Units depending upon resource allocation (and indeed Teams may be transferred between Units depending upon resource allocation as discussed above) and related Jobs will then be viewable.

Because of the Excel™ like nature of the Jobs Register interface, headings can be “dragged and dropped” to present the information in any way that may be required by the operator. For example, jobs can be grouped by Street Name, as shown in FIG. 7. As discussed above, selected jobs can be used to build Activity Reports.

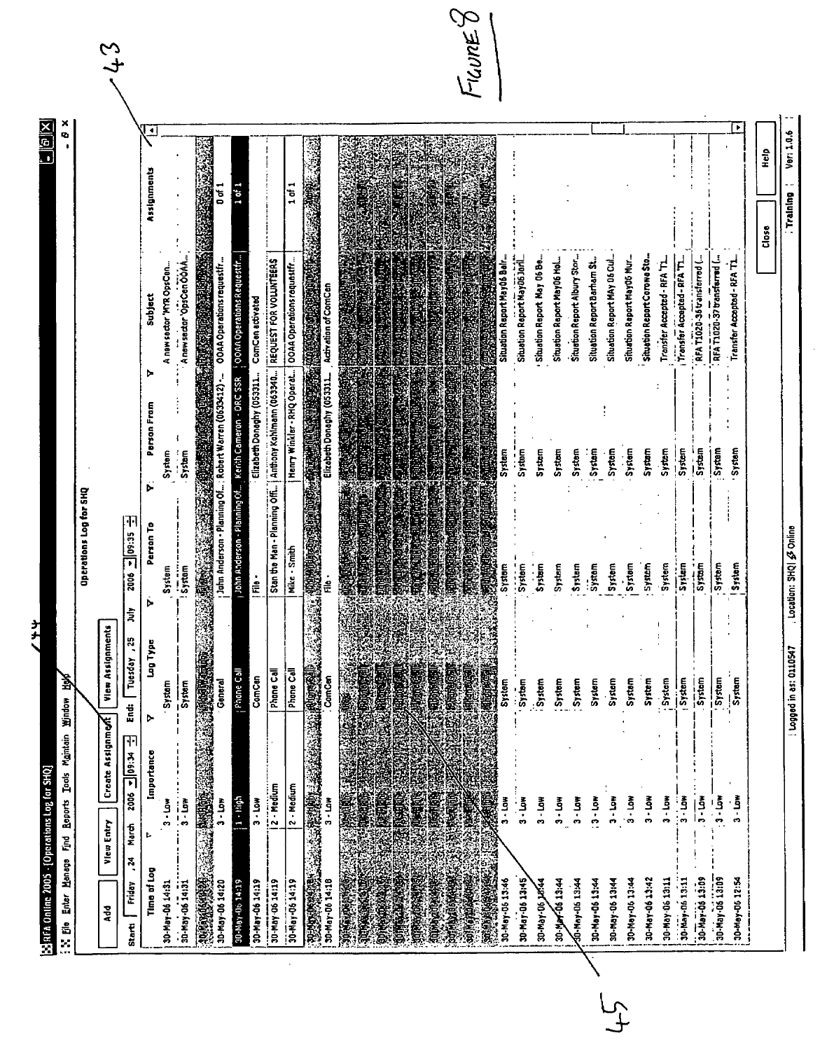

As discussed above, record keeping is an important feature of this system. An Operations Log is provided for each computing device by the system. An extract from an Operations Log is illustrated in FIG. 8. The Operations Log is useful for record keeping. For the present system, and prior art systems, information and operations centre (Region, Unit, or State) is recorded on paper and retained in multiple files. The Operations Log in this system is a tool that enables incoming and outgoing information in operations centre and key decisions to be recorded and shared. Each headquarters has its own individual Operations Log.

The Operations Log incorporates mechanisms to enable senior operations controllers to record sensitive decisions without making them available. Security over access can be implemented so that only certain operators are allowed to access to certain information.

Tasking between various headquarters can be performed and monitored directly from the Operations Log, by way of the Assignment section, reference numeral 43. A Create Assignment button 44 enables an operator to send for another Unit, Region or headquarters or to another person, an Assignment A. The Assignment may not be a task, but merely be a record of the Operations Log which the operator believes the other person (for example a manager) should view).

The Operations Log can be used to replay an operation after the event, focussing on critical decision points during a de-brief, to ensure that performance of the emergency systems response is maintained or improved in the future. It can also be useful during legal enquiries, to provide a complete record of Events that may have occurred in an emergency. All entries on the system may be included in the Operations Log, including, for example, information from the Bureau of Meteorology (reference numeral 17 FIG. 1), incoming logs of phone calls (reference numeral 44), Situation Reports, Activity Reports, Event Reports, etc.

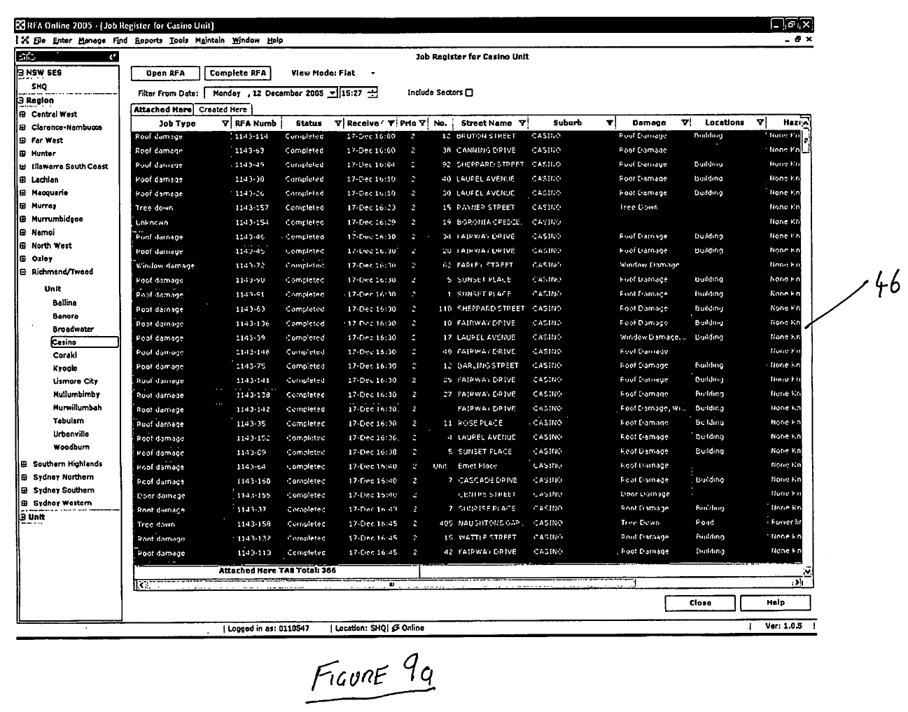

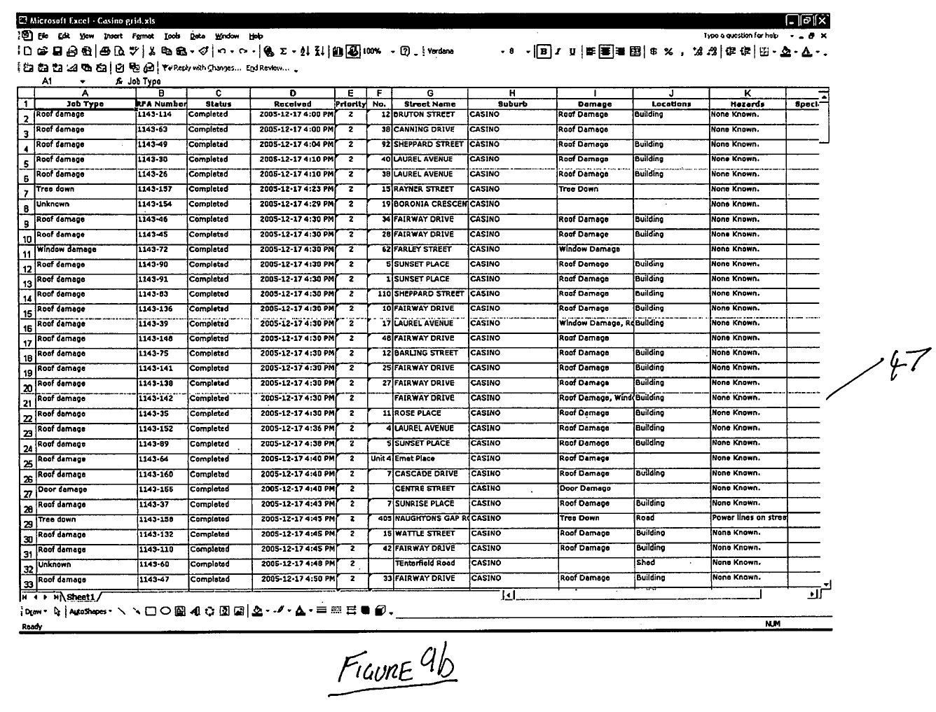

Another feature of the system is the ability to export information into other packages outside the system. Referring to FIGS. 9a and 9b, the information to be exported is selected, reference numeral 46 and can then be exported into Excel™ (reference numeral 47) for example, and can then be shared with other systems and agencies e.g. by sending by email etc.

Another feature of the system is the ability to add “To Do Custom Tags” to any RFA. For example, if a local council wanted information on a species of tree that was causing particular damage e.g. the limbs of these types of trees were falling off often, then any jobs where these trees are an issue may be Tagged. A report may then be provided via a search function searching for the Tags of these particular trees.

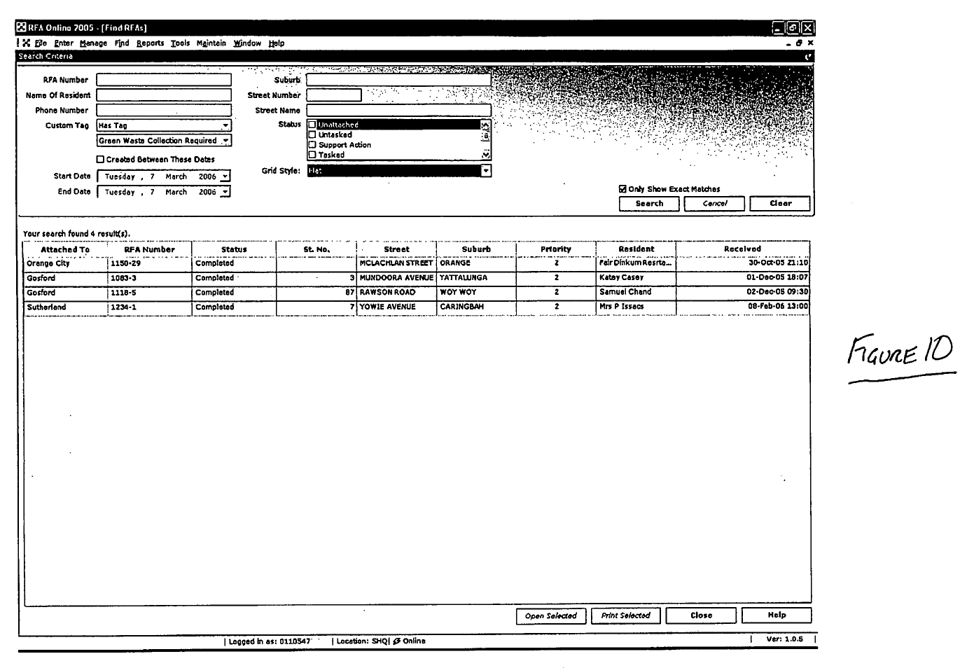

An example report is given in FIG. 10 showing a number of jobs where Green Waste Collection is required, because trees have had to be chopped down and left at the location. This information may be exported to the council, who can then send around waste collection vans. Custom Tags can be used to report on any particular item that requires some follow up task (such as the council collecting waste).

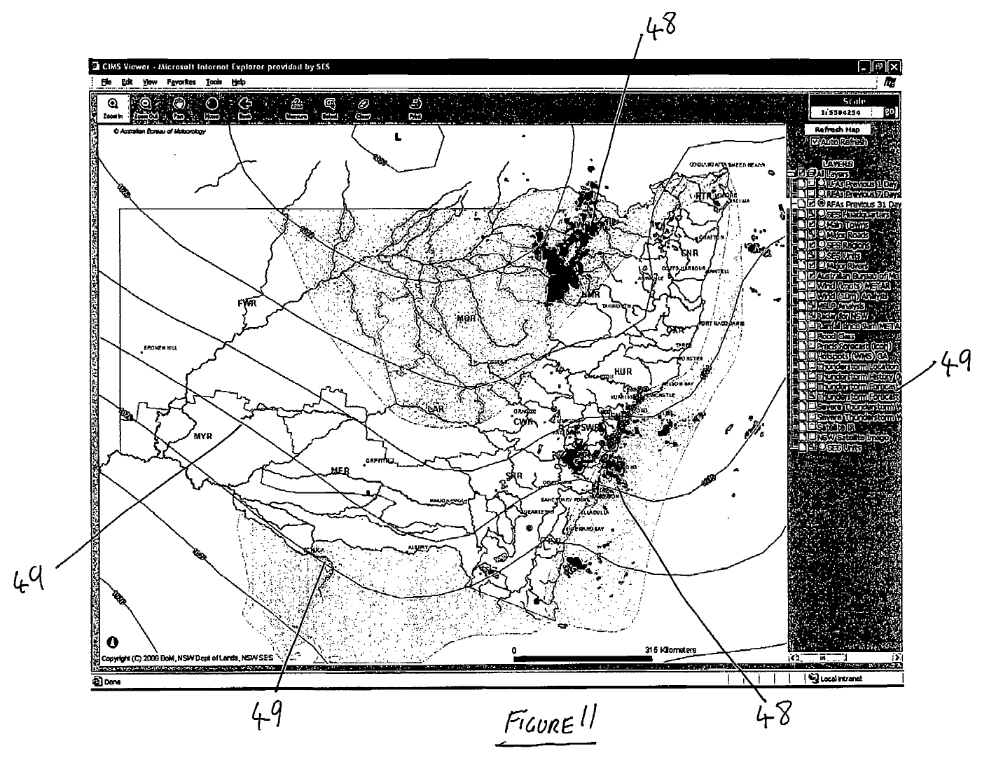

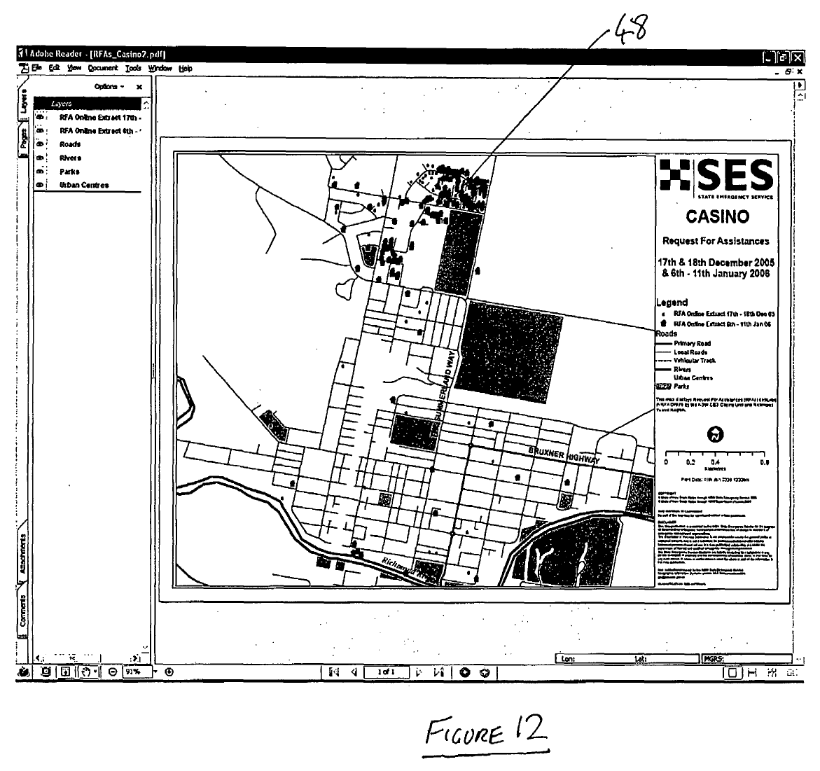

As discussed above, the system is interfaced with a mapping software and also meteorology information. This enables maps to be produced such as shown in FIG. 11 which include locations of RFAs, reference numeral 48, meteorology information, reference numeral 49 and geographical information. A further map is shown in FIG. 12, showing a more localised area.

Using this mapping software, headquarters may be able to easily to determine where resources are required to deal with RFAs at any time.

Use of maps can enable identification of impacts that emergencies have had on communities. For example, the map in FIG. 12, identifies the impact that a severe storm may have on a community (in this case Casino).

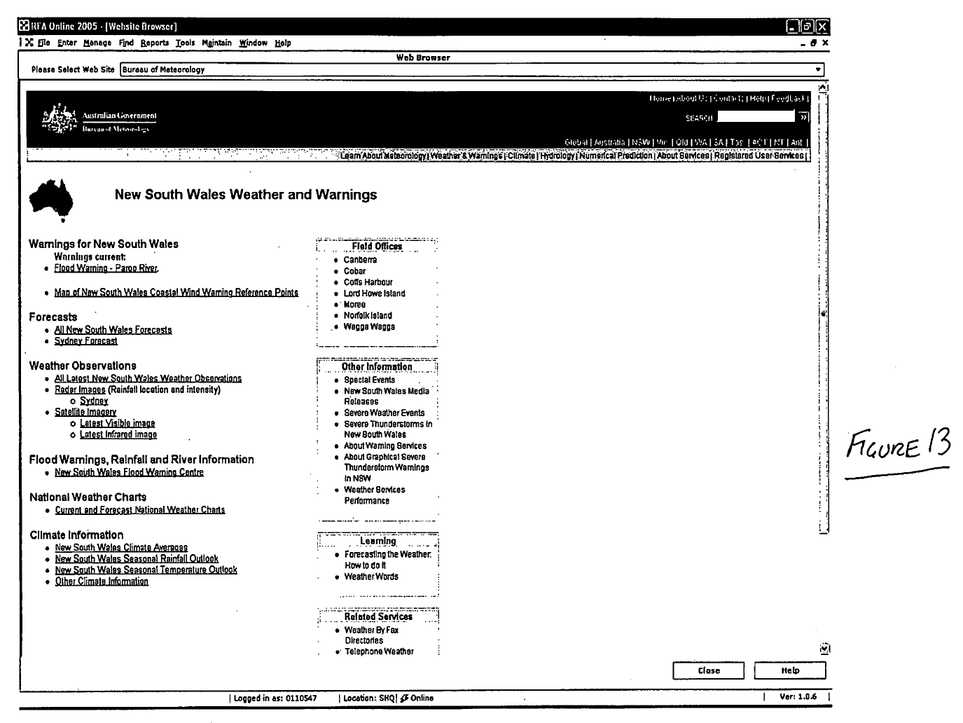

The system also provides other functionality which facilitates obtaining information. FIG. 13 shows how operational information may be sourced or shared through a number of websites. Links to each website are available from a dropdown list at the top of the screen, including the SES corporate website, emergency services organisations, the system (termed “SES Online”), the State emergency operations centre, the Bureau of Meteorology. Other links may also be provided.

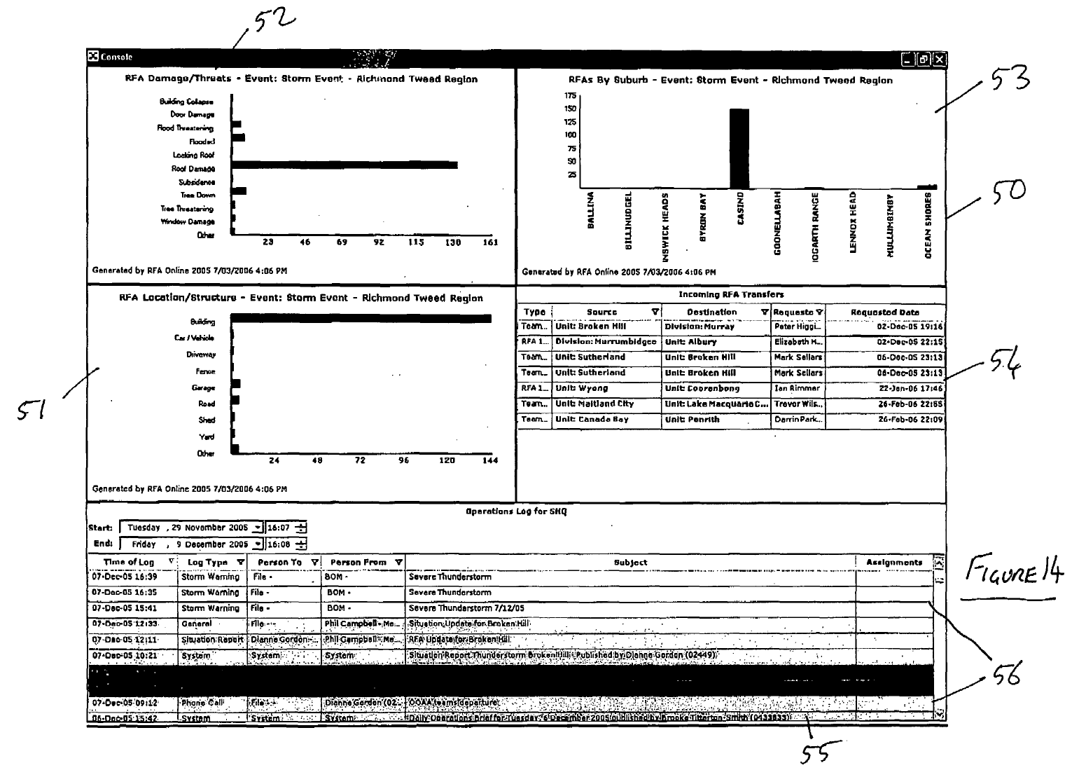

FIG. 14 shows a customisable management console view, reference numeral 50. This customisable console enables each user to configure a display of charts, graphs and textual information that is relevant to the role they are performing. It can also be automatically set to open when the system starts up. Updates may be provided in real time. In this case there are three graphs, 51, 52, 53 that provide information on request for assistance by suburb, by structure. On the centre right of the console information on the transfer of Teams and Requests for Assistance is displayed, reference numeral 54.

At the bottom of the console, entries in the state headquarters operation log are displayed, reference numeral 55. These entries are colour coded, 56, based on importance (or priority).

Each headquarters in the hierarchy is able to view the Tasks that they alone are responsible for, utilizing this type of management console. The headquarters management console will therefore be able to give a total overview. The Units will be able to view the information that is required for them to deal with their tasks.

Another feature of the geo-mapping system interface is that map references may be provided to Teams responding to emergencies.

As discussed, Sectors may be created by various headquarters in the hierarchy of the system. Sectors may be based on functional requirement, (e.g. jobs that require large ladders as a resource), geographical boundaries or personnel requirements (for example, doctors required at these particular jobs). Sectors can be used to allocate Teams and control response.

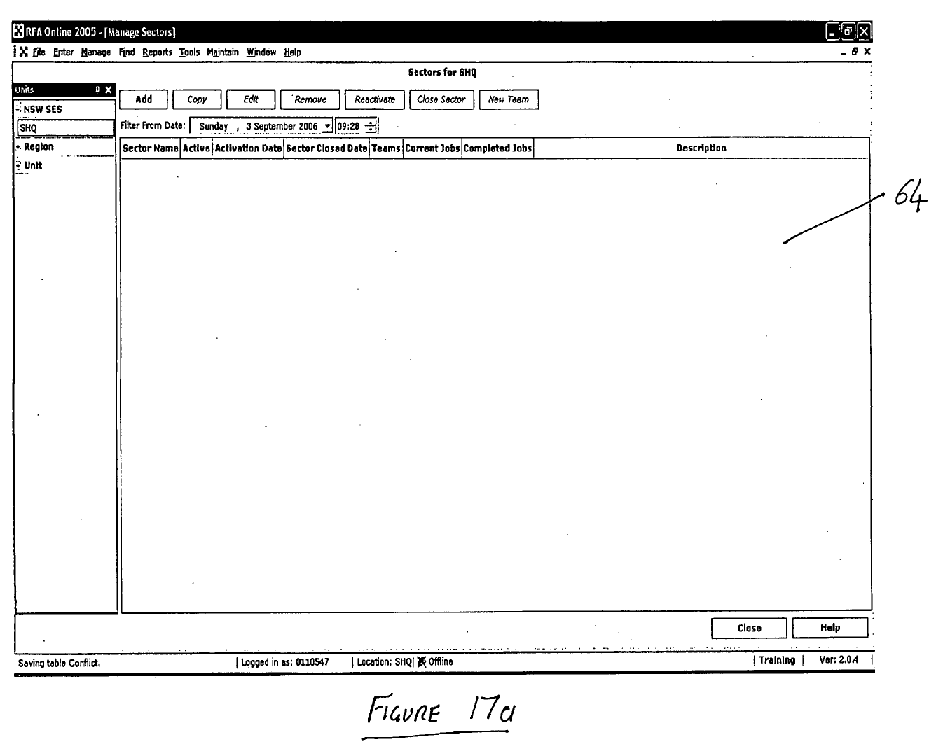

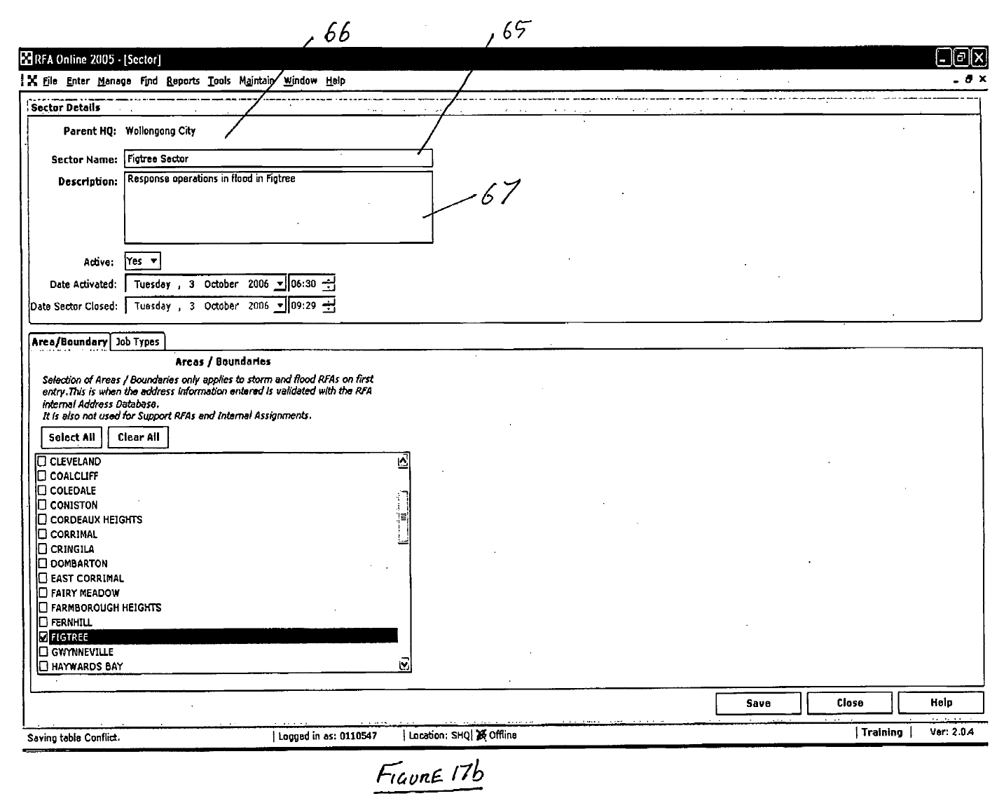

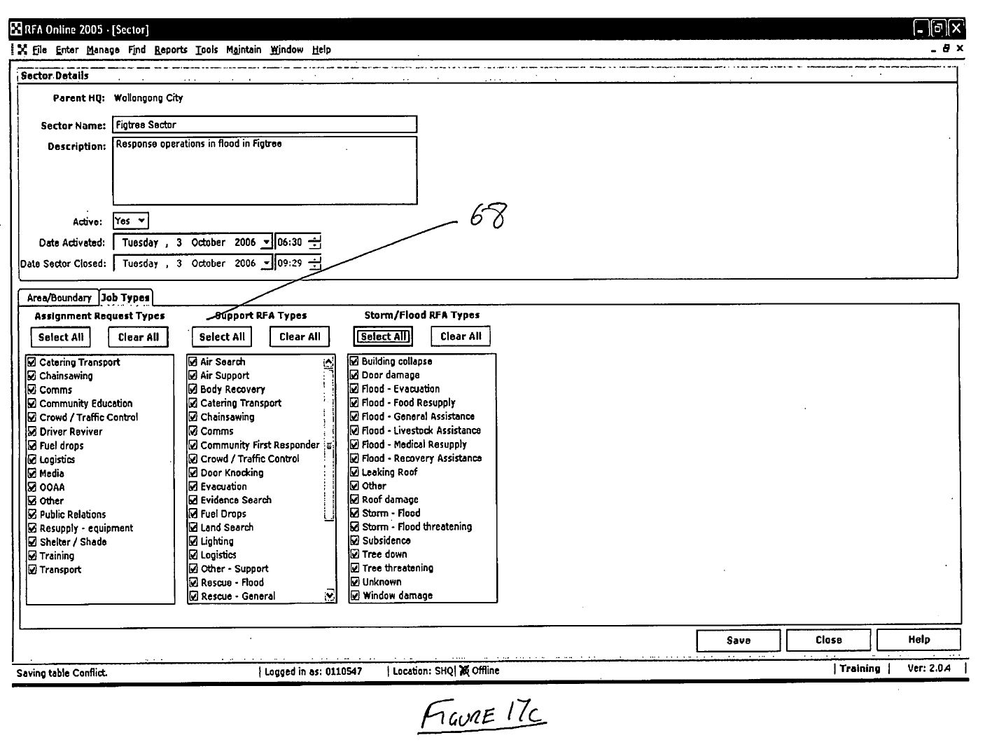

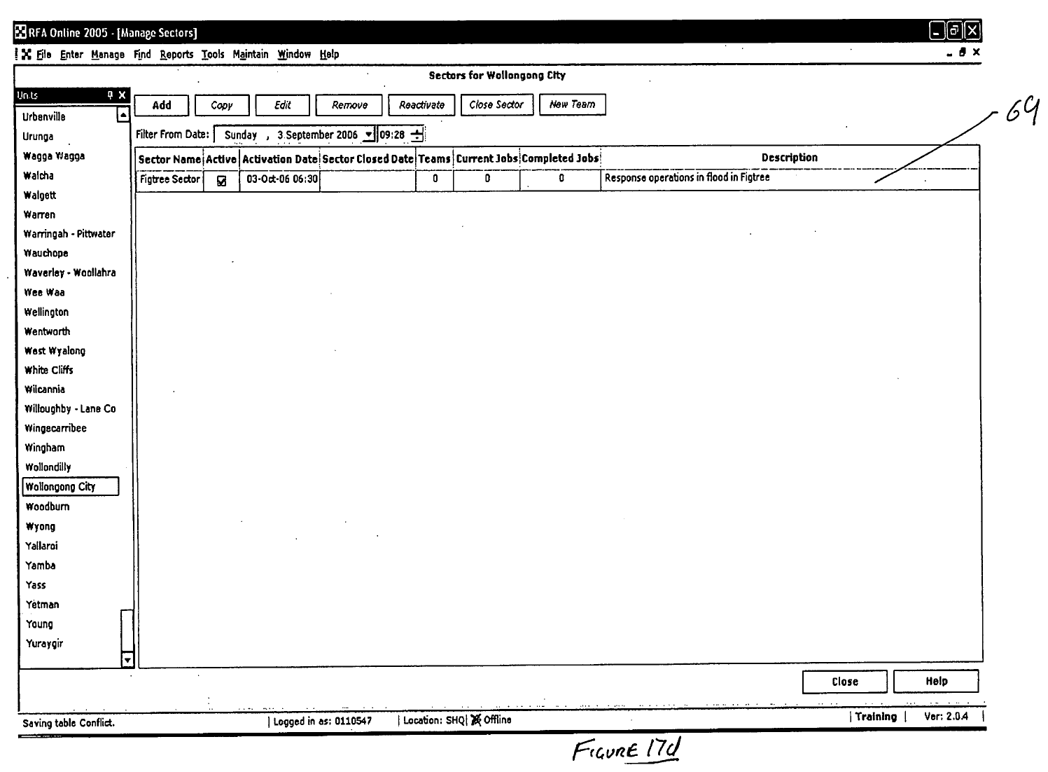

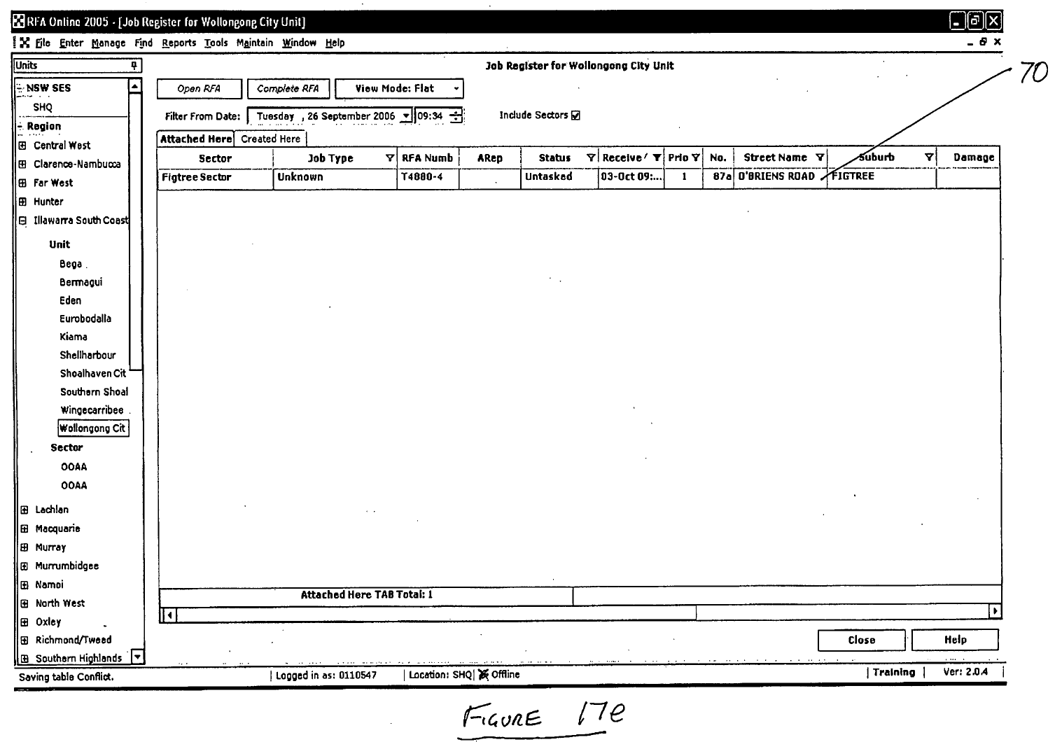

FIGS. 17a to 17e illustrate how a Sector may be allocated using the system interface. A Sector is a means of logically grouping tasks based on geographic boundaries, function or personnel. By default each Unit throughout the State is a Sector as it has a geographic boundary (in the example of the SES in Australia). However, these can be divided further based on how a Unit wishes to manage its jobs. FIG. 17a shows a Sector Management screen, reference numeral 64. FIG. 17a onwards shows the creation of a geographical sector, in this example being the “Figtree” Sector FIG. 17b shows allocation of a Sector name, reference numeral 65, within the Wollongong city parent headquarters reference numeral 66. A description, reference numeral 67 shows what the Figtree Sector has been created for. FIG. 17c shows the ability to select job types for the Sector, reference numeral 68. In this example, all available job types are selected. FIG. 17d shows that the Sector is created, reference numeral 69 and FIG. 17e shows that a job, reference numeral 70, has been transferred to the Figtree Sector (FIG. 17a shows the job register for Wollongong city, Figtree Sector).

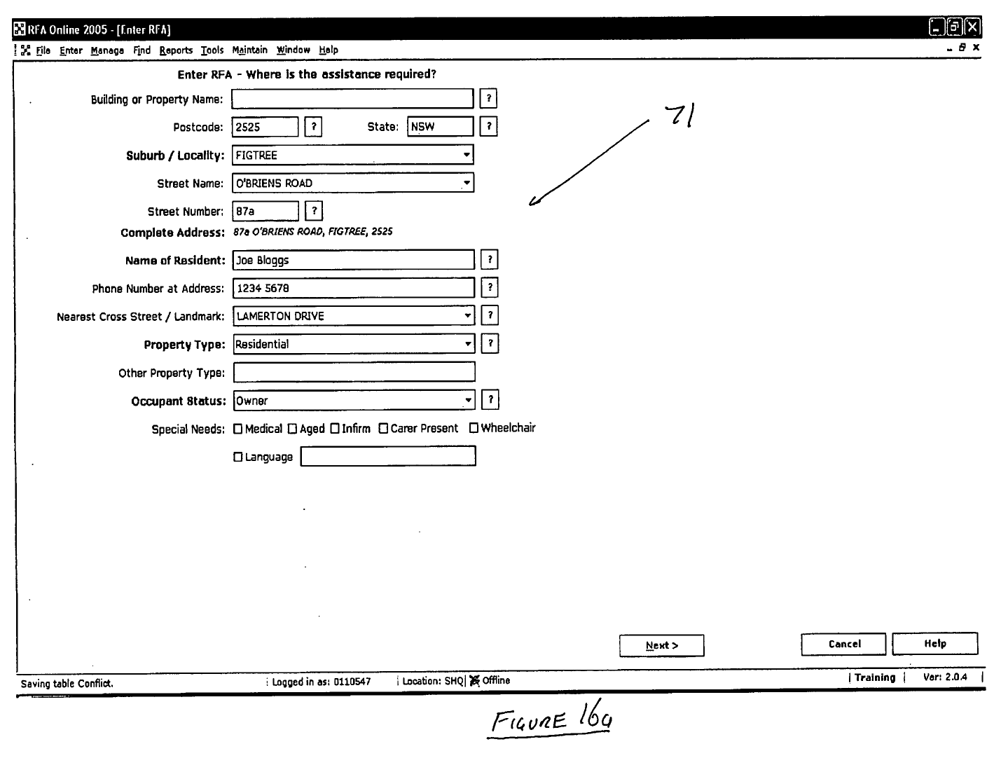

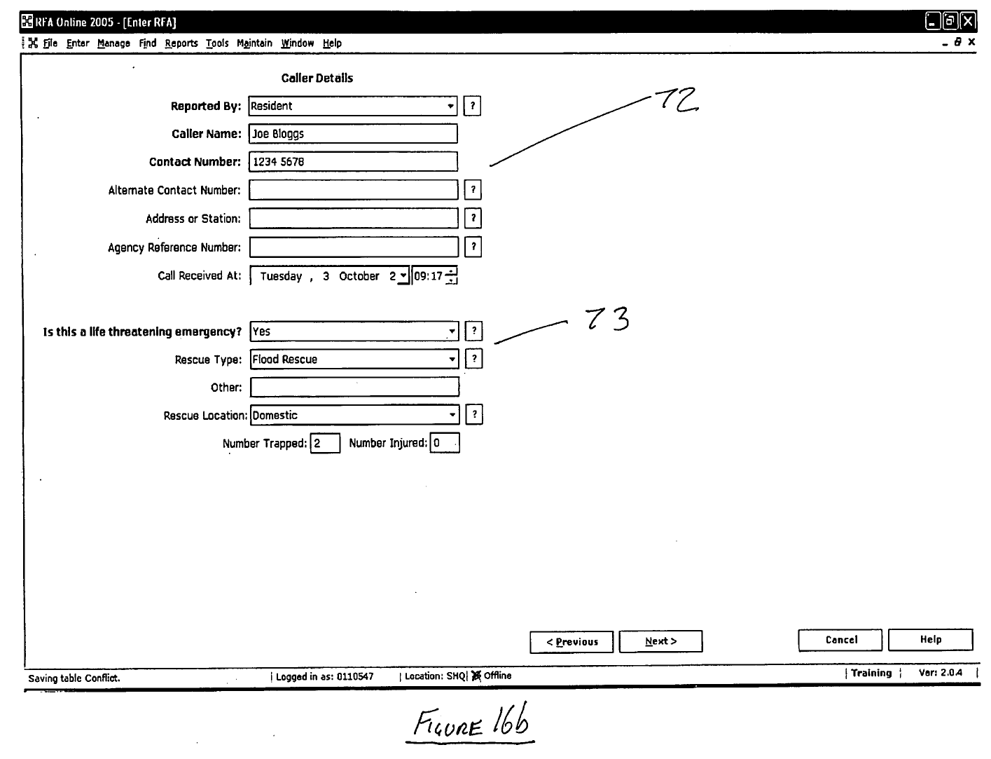

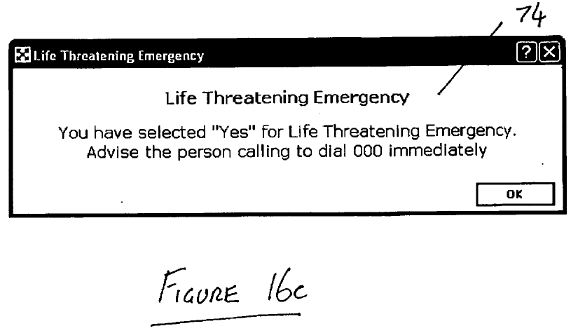

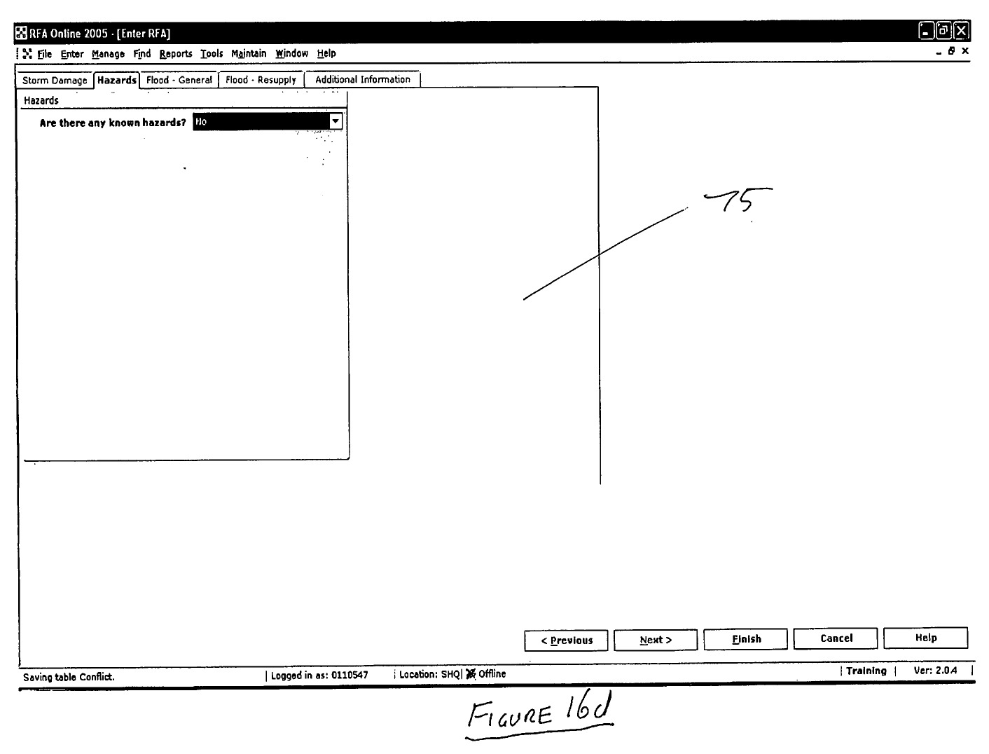

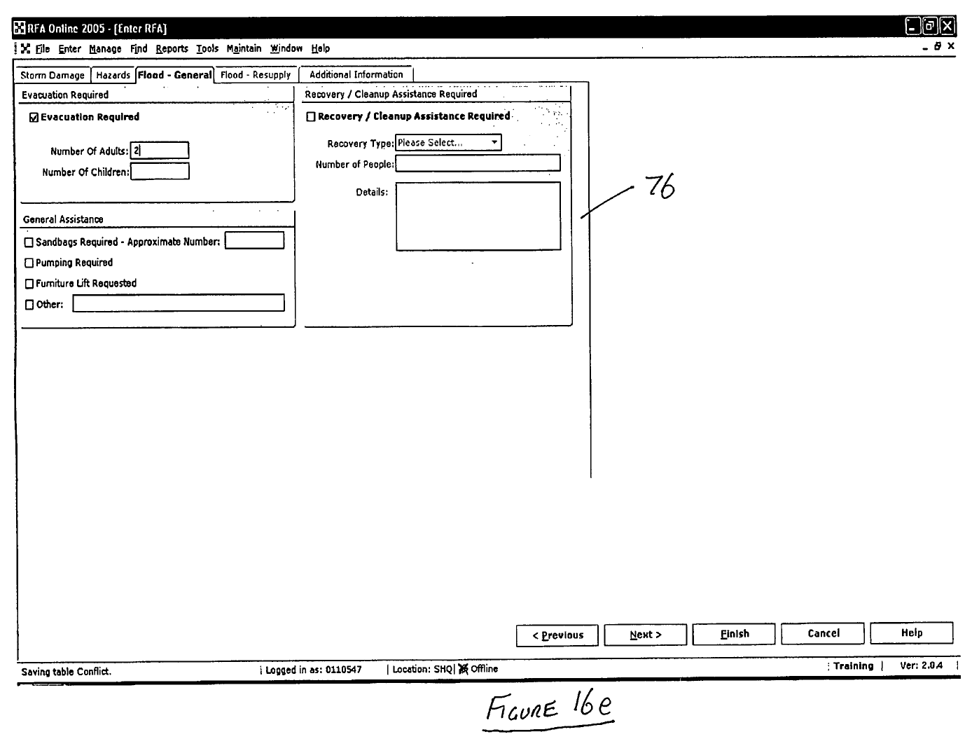

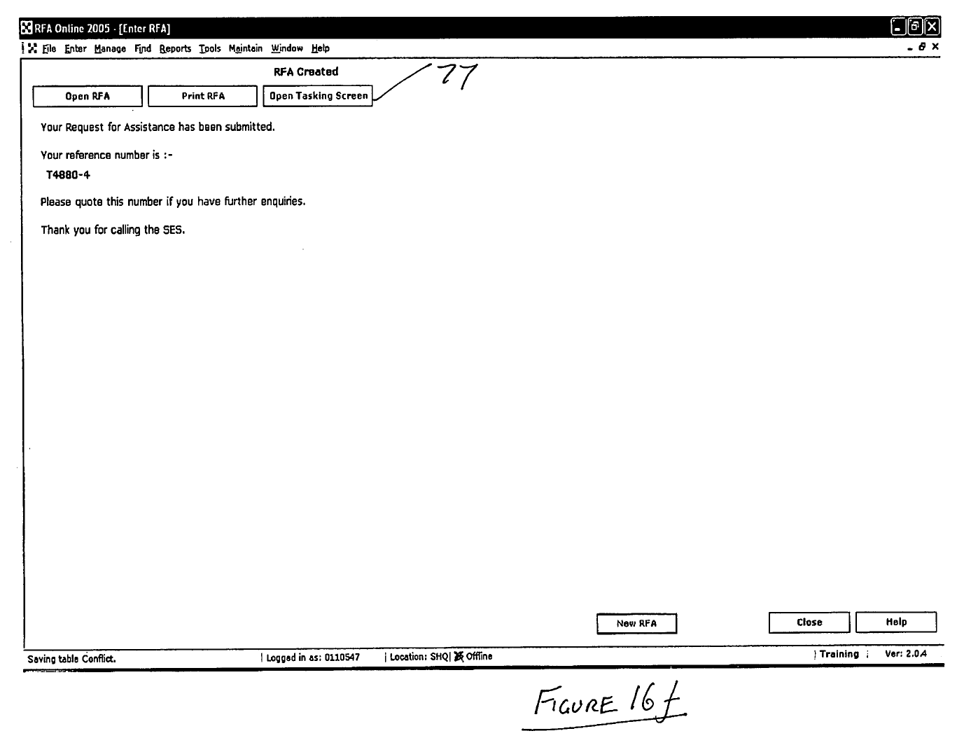

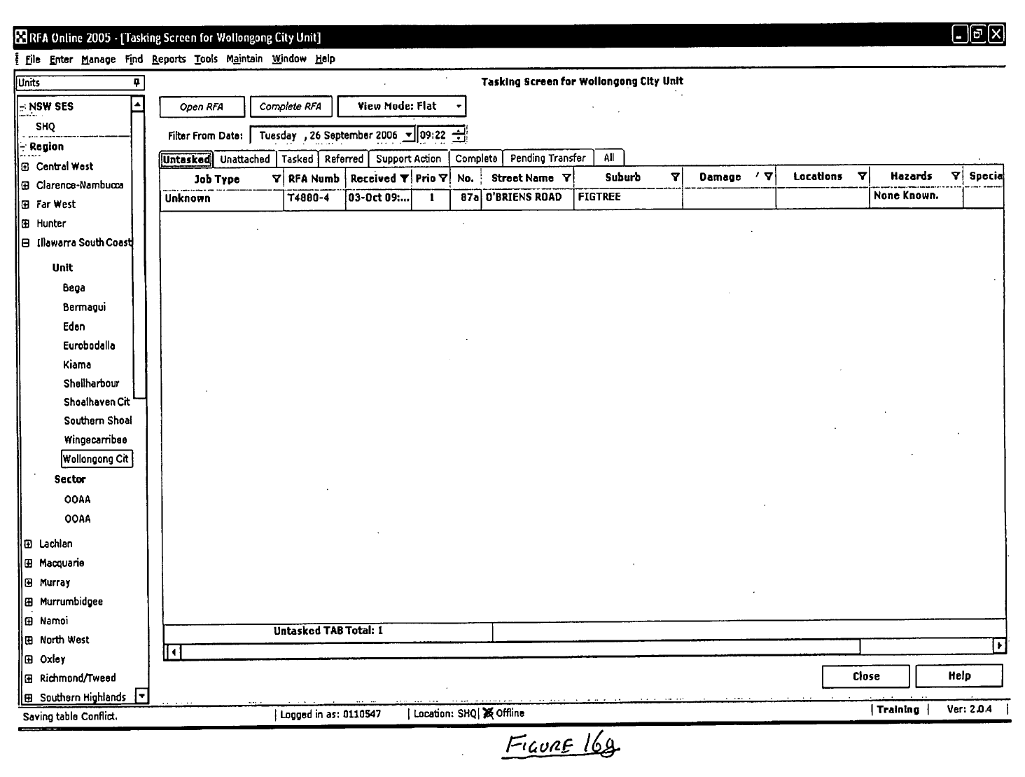

FIG. 16a through 16f show a further entering of RFA data. FIG. 16a shows the location screen, reference numeral 71, with entered details. FIG. 16b shows caller details, reference numeral 72 and also priority, reference numeral 73. In this case, it is considered that the emergency is a life threatening emergency. A message flag, reference numeral 74, FIG. 16c asks the operator to confirm that the emergency is indeed life threatening and also advises the operator to tell the Caller to dial the Police Force and Ambulance immediately (in Australia).

FIG. 16d shows the Hazards screen 75, FIG. 16e shows further details required to be entered, reference numeral 76. FIG. 16f is the last screen for RFA and includes buttons which can transfer the operator to a Tasking screen, reference numeral 77.

The system of this embodiment enables efficient provision of updates. When updates to the software are made, they may be distributed from the host computing system to the remote computing systems when communications are active. RFAs may include RFAs from other agencies or between SES headquarters. Similarly, database screen may be varied from the host system, entered by the host system, downloading the varied scheme to the remote computing systems.

In this embodiment, programming is reproduced in the host and remote systems in order to provide the common system interface and ensure that information kept on the various computer systems is reproducible.

Team debriefs may be recorded in the system as an Activity Report for review later.

On completion of a job, operators may capture the time, activities undertaken and follow up action required by the SES or any other agency and any equipment that was used or left on site. This facilitates future prediction of resources required.

The functionality of the embodiment described above may be implemented by appropriate software/hardware.

The present invention is not limited to the architecture of host computing system and remote computing system as discussed above. In some cases, stand alone systems may be utilised to serve a particular area, for example where an area is small or otherwise only requires a single computing system to serve it, for example.

Functionality of the above embodiment is implemented mainly via graphical user interface. This is not the only way of implementing the interface. Other types of interface could be utilised which are non graphical.

In the claims which follow and in the preceding description of the invention, except where the context requires other due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A system for coordinating remote response services, comprising:
a host computing system comprising a host computing system interface configured to enable entry of a request for assistance (RFA) and to enable allocation of a task responsive to the RFA; and
a remote computing system comprising a remote computing system interface configured to enable entry of an RFA and enabling allocation of a task responsive to the RFA, the remote computing system further comprising functionality that is sufficient to enable entry of an RFA and allocation of a task responsive to the RFA in the absence of communication connection to the host computing system.

2. The system in accordance with claim 1, wherein the remote computing system is allocated one or more sectors, and has sufficient functionality for those sectors.

3. The system in accordance with claim 1, wherein the host computing system comprises functionality that is sufficient for a plurality of sectors allocated to a plurality of remote systems.

4. The system in accordance with claim 1, wherein the sectors are based on geographical areas.

5. The system in accordance with claim 1, wherein the sectors are based on service personnel available.

6. The system in accordance with claim 1, wherein the sectors are based on types of tasks that are allocated.

7. The system in accordance with claim 1, wherein at least one of the host computing system and remote computing system comprises means for defining or creating sectors.

8. The system in accordance with claim 1, further comprising means for synchronizing data between the host computing system and remote computing system when a communication link is established between them.

9. The system in accordance with claim 1, wherein the RFA comprises RFA data, comprising location data providing information on the location of an RFA incident, and incident data, providing incident information on a RFA incident.

10. The system in accordance with claim 9, wherein the RFA data further comprises priority data, providing information on a priority status of the RFA incident.

11. The system in accordance with claim 10, further comprising means for setting priority data arranged to set the priority date in response to the RFA incident data.

12. The system in accordance with claim 10, wherein the host computing system and remote computing system enable a user to set the priority data.

13. The system in accordance with claim 11, wherein at least one of the host computing system interface and remote computing system interface enables a user to define further priority data settings.

14. The system in accordance with claim 1, wherein at least one of the host computing system interface and remote computing system interface is configured to enable designation of a task and allocation of resources to the task, for dealing with an RFA.

15. The system in accordance with claim 14, wherein at least one of the host computing system interface and remote computing system interface is configured to enable logging of transfer of resources between sectors for dealing with RFAs.

16. The system in accordance with claim 1, further comprising comparison means for comparing RFAs, and to provide an alert if the comparison means considers that there is a duplicate entry.

17. The system in accordance with claim 1, further comprising a job register, the job register comprising job register data comprising information about status of RFAs.

18. The system in accordance with claim 17, wherein the job register entries are priority coded.

19. The system in accordance with claim 17, wherein the job register entries are accessible via an interface which enables grouping and sorting of job register entries.

20. The system in accordance with claim 17, wherein the job register comprises information on the jobs registered and the job registers of all the remote computing systems, whereby to facilitate allocation of resources.

21. The system in accordance with claim 17, further comprising an operations log, the operations log being arranged to store information on operations of the remote response services.

22. The system in accordance with claim 21, wherein the host computing system is configured to access the operations logs of the remote computing systems.

23. The system in accordance with claim 21, wherein the operation log provides a record of operation information of the remote response services.

24. The system in accordance with claim 1, further comprising an interface with a geo-mapping system, enabling the system to have access to location and mapping information.

25. The system in accordance with claim 24, wherein at least one of the host computing system interface and remote computing system interface is configured to prompt entry of location information utilizing the geo-mapping system to guide users entering location information for an RFA.

26. The system in accordance with claim 24, wherein at least one of the host computing system interface and remote computing system interface is configured to produce maps by interfacing with the geo-mapping system, the maps comprising graphical indication of location of RFAs.

27. The system in accordance with claim 26, wherein the maps display a priority status of the RFAs.

28. The system in accordance with claim 1, further comprising means for calculating resources required to deal with entered RFAs.

29. The system in accordance with claim 1, further comprising tagging means for allocating tags to RFAs and for alerting of follow up tasks.

30. The system in accordance with claim 29, comprising search means for searching for tags in order to consolidate follow up tasks.

31. The system in accordance with claim 1, comprising situation report means for enabling entry of situation reports comprising information about response situations.

32. The system in accordance with claim 1, comprising means for preparing activity reports arranged to utilize information from RFAs to build activity reports.

33. The system in accordance with claim 1, comprising an event recording means for recording of information about emergency events relating to RFAs.

34. The system in accordance with claim 33, wherein data from entered RFAs are utilized to prepare event reports.

35. A remote computing system for coordinating remote response services, the system comprising:
a remote computing system interface enabling entry of a request for assistance (RFA) and enabling allocation of a task responsive to the RFA, the remote computing system comprising functionality that is sufficient to enable entry of an RFA and allocation of a task responsive to the RFA in the absence of communication connection to a host computing system.

36. A system for coordinating remote response services, comprising:
a host computing system, comprising a host computing system interface enabling entry of a request for assistance (RFA) and enabling allocation of a task responsive to the RFA, and being arranged to communicate with a remote computing system, when communications are available, in order to upload/download data between the host computing system and the remote computing system.

37. A system for coordinating remote response services, comprising a computing system, comprising a computing system interface enabling entry of a Request For Assistance (RFA) and enables allocation of a task responsive to the RFA.

38. A method of coordinating remote response services, the method comprising:
entering details of a request for assistance (RFA); and
allocating a task responsive to the RFA on a computing system in accordance with claim 1.

39. A computer program comprising instructions for controlling a computer to implement a system in accordance with claim 1.

40. A computer readable medium providing a computer programme in accordance with claim 39.

41. A computer program comprising instructions for controlling of a computer to implement a system in accordance with claim 35.

42. A computer readable medium providing computer programme in accordance with claim 41.

43. A computer program, comprising instructions for controlling a computer to implement a system in accordance with claim 36.

44. A computer readable medium providing a computer programme in accordance with claim 43.

45. A computer program, comprising instructions for controlling a computer to implement a system in accordance with claim 37.

46. A computer readable medium providing a computer programme in accordance with claim 45.
